(19) United States
(12) Patent Application Publication
(10) Pub. No.: US 2025/0196138 A1
(43) Pub. Date: Jun. 19, 2025

(54) ASSAY DEVICE

(71) Applicant: NATIONAL INSTITUTE OF ADVANCED INDUSTRIAL SCIENCE AND TECHNOLOGY, Tokyo (JP)

(72) Inventors: Yusuke FUCHIWAKI, Takamatsu-shi, Kagawa (JP); Shohei YAMAMURA, Takamatsu-shi, Kagawa (JP)

(21) Appl. No.: 18/852,259

(22) PCT Filed: Apr. 20, 2023
(86) PCT No.: PCT/JP2023/015770

§ 371 Date: Sep. 27, 2024

(30) Foreign Application Priority Data
Apr. 21, 2022 (JP) 2022-070245

(51) Int. Cl. B01L 3/00

(52) U.S. Cl. CPC B01L 3/502753; B01L 3/5023; B01L 2300/069; B01L 2300/0809; B01L 2400/086

(57) ABSTRACT

Provided is an assay device that enables a liquid to be stably replaced inside a microflow passage even in a case of a liquid with a relatively small interfacial tension and a microflow passage with an interfacial tension weakened due to a surface treatment such as a blocking treatment. The assay device includes: an inlet 2; an inner flow passage 3 through which a liquid injected from inlet 2 flows; and a liquid absorbing material 4 that absorbs the liquid that has passed through inner flow passage 3, the inner flow passage 3 includes a microflow passage 31 that includes an assay region 31c and a separating flow passage 32 that is provided between the microflow passage 31 and the liquid absorbing material 4 for separating the liquid therein when injection of the liquid is stopped, and the separating flow passage 32 includes a flow passage surface changing portion that provides a change in a surface of the separating flow passage 32 with which the liquid comes into contact.

### TECHNICAL FIELD

The present invention relates to an assay device, and particularly to an assay device capable of performing an assay using a small amount of liquid.

### BACKGROUND ART

An assay device described in Patent Document 1 is known as an example of assay devices in the related art of this type. The assay device described in Patent Document 1 includes a microflow passage configured to allow fluid to flow, an absorbing porous medium disposed at a distance from one end of the microflow passage, the one end being positioned at one end in a flow direction of the fluid, a separating space disposed between the one end of the microflow passage and the absorbing porous medium, and two sideways ventilation passages being adjacent to both sides of the microflow passage, respectively in a width direction orthogonal to the flow direction, the two sideways ventilation passages being communicated with the microflow passage to allow air circulation.

### CITATION LIST

### Patent Literature

Patent Document 1: International Publication No. WO 2020/045551 A1

### SUMMARY OF INVENTION

### Problem to be Solved by the Invention

According to the assay device described in Patent Document 1, it is possible to replace a liquid inside the microflow passage from a first liquid to a second liquid, that is, it is possible to perform replacement of liquid inside the microflow passage by injecting an amount of second liquid exceeding the amount of first liquid into the microflow passage when the microflow passage is filled with the first liquid.

However, in a case of a liquid with a small interfacial tension, there is a concern that the liquid cannot stably stay inside the microflow passage. If the liquid does not stably stay inside the microflow passage, it is difficult for the liquid to maintain a stable shape inside the microflow passage. As a result, replacement of the liquid inside the microflow passage cannot be stably performed due to mixture of air inside the microflow passage or the like.

Here, there is a trend that sample solutions (extracted solutions and the like) in biochemical tests have small interfacial tensions because relatively large amounts of surfactant are contained in many cases and due to influences of a blocking agent used for a blocking treatment of the surface of the microflow passage. Also, multi-stage reactions as in enzyme-linked immunosorbent assay (ELISA) may be needed for treatments of sample solutions in biochemical tests. For these reasons, there has been a demand to stably perform replacement of a liquid inside the microflow passage particularly in a case where a sample solution in a biochemical test is used.

Note that such a demand is not limited to a case where a sample solution in a biochemical test is used and is common to a case where a liquid with a relatively small interfacial tension is used.

Thus, an object of the present invention is to provide an assay device that enables a liquid to be stably replaced inside a microflow passage even in a case of a liquid with a relatively small interfacial tension and a microflow passage with an interfacial tension weakened due to a surface treatment such as a blocking treatment.

### Means For Solving the Problems

According to an aspect of the present invention, there is provided an assay device including: an inlet; an inner flow passage through which a liquid injected from the inlet flows;

and a liquid absorbing material that absorbs the liquid that has passed through the inner flow passage, the inner flow passage including a microflow passage that includes an assay region, and a separating flow passage that is provided between the microflow passage and the liquid absorbing material for separating the liquid inside the inner flow passage into a part that is left in the microflow passage and a part that is absorbed by the liquid absorbing material when injection of the liquid is stopped, and the separating flow passage including a flow passage surface changing portion that provides a change in a surface of the separating flow passage with which the liquid comes into contact. ADVANTAGEOUS EFFECTS OF INVENTION

According to the present invention, it is possible to provide an assay device that enables a liquid to be stably replaced inside a microflow passage even in a case of a liquid with a relatively small interfacial tension and a microflow passage with an interfacial tension weakened due to a surface treatment such as a blocking treatment.

### BRIEF DESCRIPTION OF DRAWINGS

FIG. 1 is a perspective view of an assay device according to a first embodiment.

FIG. 2 is a sectional view of the assay device according to the first embodiment.

FIG. 3 is an exploded perspective view of the assay device according to the first embodiment.

FIGS. 4A to 4C are diagrams illustrating an upper flow passage forming member, in which FIG. 4A is a top view of the upper flow passage forming member, FIG. 4B is a side view of the upper flow passage forming member, and FIG. 4C is a bottom view of the upper flow passage forming member.

FIGS. 5A to 5D are diagrams illustrating a lower flow passage forming member, in which FIG. 5A is a top view of the lower flow passage forming member, FIG. 5B is a side view of the lower flow passage forming member, FIG. 5C is a bottom view of the lower flow passage forming member, and FIG. 5D is a sectional view along A-A in FIG. 5A.

FIGS. 6A and 6B are diagrams illustrating an intermediate member disposed between the upper flow passage forming member and the lower flow passage forming member, in which FIG. 6A is a top view of the intermediate member, and FIG. 6B is a side view of the intermediate member.

FIGS. 7A and 7B are diagrams for explaining an inner flow passage and an inner ventilation space, in which FIG. 7A mainly illustrates an upper portion of the inner flow passage, and FIG. 7B mainly illustrates a lower portion of the inner flow passage.

FIGS. 8A to 8D are diagrams for explaining motion of a first liquid injected into the assay device and are diagrams schematically illustrating the inner flow passage and the like when the assay device is seen from above.

FIGS. 9A to 9D are diagrams for explaining motion of the first liquid and a second liquid when the second liquid is injected after injection of the first liquid into the assay device is stopped and are diagrams schematically illustrating the inner flow passage and the like when the assay device is seen from above.

FIGS. 10A to 10F are schematic sectional views of a boundary region between a separating flow passage and a liquid absorbing material.

FIG. 11 is a perspective view of an assay device according to a second embodiment.

FIG. 12 is an exploded perspective view of the assay device according to the second embodiment.

FIG. 13 is a sectional view of an assay device according to a third embodiment.

FIG. 14 is an exploded perspective view of the assay device according to the third embodiment.

FIG. 15 is an exploded perspective view of an electrochemical assay device according to a fourth embodiment.

FIGS. 16A and 16B are diagrams of a structure (including a liquid absorbing material) in which an upper flow passage forming member, a lower flow passage forming member, and an intermediate member are stacked and integrated, where FIG. 16A is a perspective view of the structure, and FIG. 16B is a sectional view along B-B in FIG. 16A.

FIG. 17 is a schematic sectional view of a boundary region between a separating flow passage and a liquid absorbing material according to a first modification.

FIG. 18 is a schematic sectional view of a boundary region between a separating flow passage and a liquid absorbing material according to a second modification.

FIG. 19 is a schematic sectional view of a boundary region between a separating flow passage and a liquid absorbing material according to a third modification.

### MODE FOR CARRYING OUT THE INVENTION

Hereinafter, an assay device according to embodiments of the present invention will be described.

The assay device according to the embodiments is a device with which it is possible to perform an assay using a small amount of liquid. A liquid that can be used by the assay device according to the embodiments may be any liquid as long as the liquid can flow through a flow passage (inner flow passage) provided inside the assay device and is not particularly limited. Such a liquid is typically an aqueous solution. Also, the liquid that can be used in the assay device according to the embodiments includes not only a chemically pure liquid but also a liquid in which gas, another liquid, or a solid is dissolved, dispersed, or suspended.

For example, a liquid of a biological origin may be used. In a case where a liquid of a biological origin is used, it is possible to measure a specimen that is effective for diagnosis in the liquid for applications such as a pregnancy test, urinalysis, a stool test, an adult disease test, an allergy test, an infectious disease test, a drug test, and a cancer test with the assay device. Also, a suspension of food, drink water, river water, a soil suspension, and the like may be used. In a case where these are used, it is possible to measure pathogens in the food or the drink water or it is possible to measure contamination substances in the river water or the soil.

In the present specification, the “specimen” mainly refers to a compound or a composition that is detected or measured using the liquid. Examples of the “specimen” include saccharides (glucose, for example), cells, protein or peptide (serum protein, hormone, enzyme, immune regulators, lymphokine, monokine, cytokine, glycoprotein, vaccine antigens, antibodies, growth factors, and proliferative factors, for example), fat, amino acids, nucleic acids, steroids, vitamins, pathogens or antigens thereof, natural substances or synthetic chemical substances, contamination substances, therapeutic drugs or illegal drugs, and metabolites or antibodies of these substances.

Also, a “microflow passage” in the present specification refers to a flow passage inside the assay device that enables the specimen to be detected or measured using a very small amount of liquid of microliter (μl) order, that is, a liquid in amount that is as very small as not less than 1 μl and less than 1000 μl.

### First Embodiment

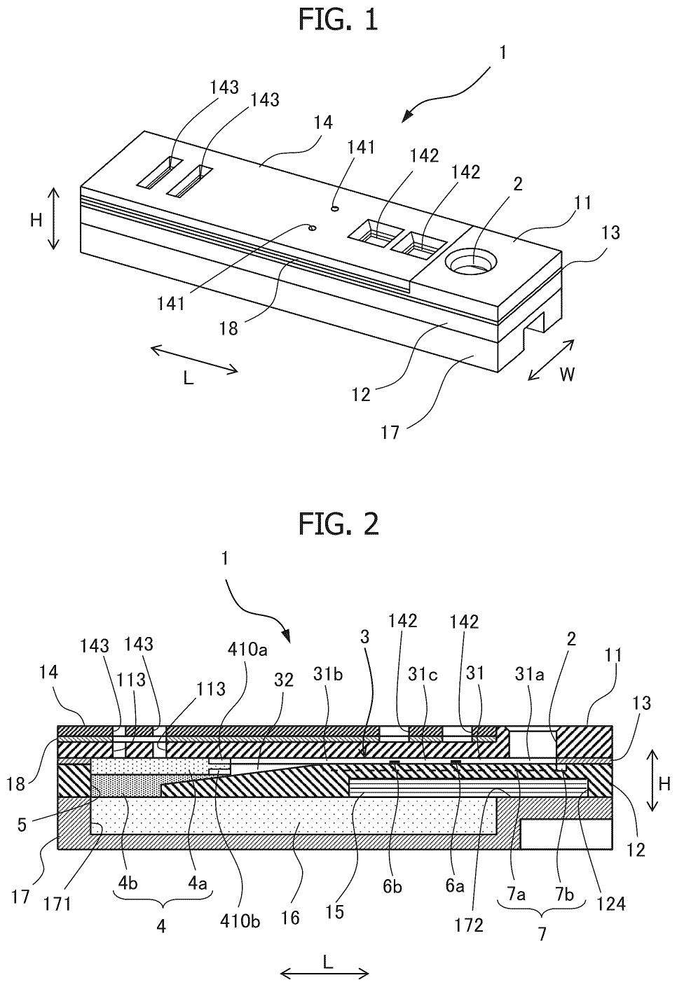

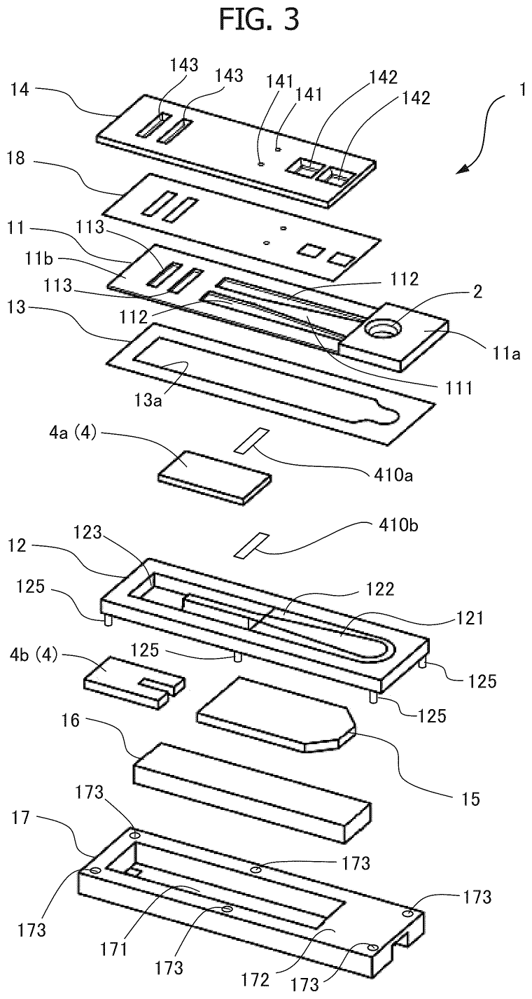

FIGS. 1 to 3 illustrate an assay device 1 according to a first embodiment. FIG. 1 is a perspective view of the assay device 1, FIG. 2 is a sectional view of the assay device 1, and FIG. 3 is an exploded perspective view of the assay device 1.

First, a basic configuration of the assay device 1 will be described.

The assay device 1 is formed into substantially a rectangular parallelepiped shape as a whole and includes an inlet 2, into which a liquid is injected (mainly injected in a dropwise manner), at one side (the right side in FIG. 2) in a longitudinal direction L. The inlet 2 is formed into a circular shape and opens in an upper surface of the assay device 1.

Also, the assay device 1 includes an inner flow passage 3 through which the liquid injected from the inlet 2 flows and a first liquid absorbing material 4 that absorbs the liquid that has passed through the inner flow passage 3. The inner flow passage 3 extends in the longitudinal direction L inside the assay device 1. The first liquid absorbing material 4 is formed of a flexible porous material capable of absorbing a liquid and is accommodated in an accommodating space 5 provided on the other side (the left side in FIG. 2) in longitudinal direction L inside the assay device 1. In other words, the longitudinal direction L is also a flowing direction of the liquid inside the assay device 1. In this case, the one side in the longitudinal direction L where the inlet 2 is located is upstream, while the other side in the longitudinal direction L where the first liquid absorbing material 4 is located is downstream.

In the present embodiment, the first liquid absorbing material 4 includes an upper absorbing material 4a and a lower absorbing material 4b. However, the first liquid absorbing material 4 is not limited thereto, may include one absorbing material.

In the present embodiment, the inner flow passage 3 includes an upper wall and a lower wall as is also obvious from FIG. 2. Furthermore, in the present embodiment, the inner flow passage 3 is defined by the upper wall and the lower wall and does not include any side walls. Also, the inner flow passage 3 includes a microflow passage 31 and a separating flow passage 32.

The microflow passage 31 constitutes an upstream-side flow passage of the inner flow passage 3, that is, a flow passage close to the inlet 2. A base end portion (upstream end) 31a of the microflow passage 31 is located in the vicinity of the inlet 2, preferably below the inlet 2 in a height direction H, and more specifically immediately below the inlet 2. A liquid injected from the inlet 2 flows into the base end portion 31a of the microflow passage 31 and flow from the base end portion 31a to the downstream side of the microflow passage 31. The microflow passage 31 extends substantially horizontally from the base end portion 31a toward the other side in longitudinal direction L with a distal end portion (downstream end) 31b located substantially at the center in longitudinal direction L.

An assay region 31c is provided at an intermediate portion of the microflow passage 31, that is, between the base end portion 31a and the distal end portion 31b. One or more assay reagents are disposed in the assay region 31c. The assay reagent is any substance that can lead to a detectable result by reacting with a liquid or a specimen contained therein and may be an antibody or an antigen, for example. Although it is preferable that the detectable result can be visually recognized by an observer with naked eyes, the detectable result is not limited thereto. The detectable result may be a result that allows visual recognition or the like by the observer using a predetermined device. The detectable result includes coloring, light absorbance, light emission, fluorescence, and the like. In a case in which an assay based on an electrochemical method is performed, the detectable result is an electrochemical signal, and an assay reagent preferably contains an electrochemical light-emitting labeling and a reducing agent. A configuration example of an assay device to perform the assay based on the electrochemical method will be described in detail in a fourth embodiment.

In the present embodiment, a first assay reagent 6a and a second assay reagent 6b are disposed to be separated from each other in the longitudinal direction L in the assay region 31c. Specifically, the first assay reagent 6a and the second assay reagent 6b are fixed to either one of the lower wall and the upper wall or both the lower wall and the upper wall of the microflow passage 31 in the present embodiment. However, the first assay reagent 6a and the second assay reagent 6b are not limited thereto. The first assay reagent 6a and/or the second assay reagent 6b may be carried by a porous material or the like that allows the liquid to pass therethrough, and the porous element (carrier) may be installed in the assay region 31c.

The separating flow passage 32 constitutes a downstream flow passage of the inner flow passage 3, that is, a flow passage close to the first liquid absorbing material 4. One end (upstream end) of the separating flow passage 32 is connected to the distal end portion (downstream end) 31b of the microflow passage 31. The separating flow passage 32 extends from the one end portion toward the other side in longitudinal direction L with the other end portion (downstream end) being in contact with the first liquid absorbing material 4.

In other words, in the present embodiment, the first liquid absorbing material 4 is provided to be separated from the distal end portion (downstream end) 31b of the microflow passage 31 in the longitudinal direction L, and the separating flow passage 32 is provided between (the distal end portion 31b of) the microflow passage 31 and the first liquid absorbing material 4. The separating flow passage 32 is configured to separate the liquid inside the inner flow passage 3 when injection of the liquid into the inlet 2 is stopped, in other words, when supply of the liquid to the inner flow passage 3 is stopped as will be described later. Specifically, the liquid inside the inner flow passage 3 is divided in the separating flow passage 32 when the injection of the liquid into the inlet 2 is stopped, a part of the divided liquid is absorbed by the first liquid absorbing material 4, and the rest stays (is left) inside the microflow passage 31.

In the separating flow passage 32, a flow passage surface changing portion that provides a change in a surface of the separating flow passage 32 with which the liquid comes into contact is further mounted in order to promote separation of the liquid on the upstream side of the first liquid absorbing material 4. The flow passage surface changing portion will be described later.

Furthermore, an inner ventilation space 7 that, in a top view, surrounds the microflow passage 31 except for the distal end portion 31b to which the one end portion (upstream end) of the separating flow passage 32 is connected and communicates with outside is provided inside the assay device 1. As described above, the inner flow passage 3 does not include a side wall in the present embodiment. Therefore, the inner ventilation space 7 also communicates with the microflow passage 31. In the present embodiment, the inner ventilation space 7 includes a pair of sideways spaces 7a and 7a (one of them is illustrated by a dashed line in FIG. 2) that are adjacent to the microflow passage 31 on both sides in a lateral direction (hereinafter, referred to as a “width direction”) W and communicates with the microflow passage 31 and a coupling space 7b that extends along an outer edge of the inlet 2 and couples the pair of sideways spaces 7a and 7a. The communication between the inner ventilation space 7 and the outside will be described later.

Referring to FIG. 2, in the present embodiment, the upper wall and the lower wall of the microflow passage 31 extend substantially horizontally, and the height of the microflow passage 31, that is, the distance between the upper wall and the lower wall of the microflow passage 31 in a height direction His constant (this is not necessarily constant in a strict sense and may be substantially constant, and the same applies to the following description) in the present embodiment. Also, the height of the microflow passage 31 is defined such that an interfacial tension of the liquid can be generated with which leakage to the inner ventilation space 7 (particularly sideways spaces) can be prevented when the liquid flows through the microflow passage 31. On the other hand, the upper wall of the separating flow passage 32 is configured with the upper wall of the microflow passage 31 being extended as it is and extends substantially horizontally, and the lower wall of the separating flow passage 32 is inclined downward such that the height position becomes lower at a greater distance from (the distal end portion 31b of) the microflow passage 31, that is, as it approaches the first liquid absorbing material 4.

Here, although not particularly limited, the height of the microflow passage 31 may be set within a range of 1 μm to 1 mm, for example, the width (the dimension in the width direction W) of the microflow passage 31 may be set within a range of 100 μm to 1 cm, for example, and the length (the dimension in the longitudinal direction L) of the microflow passage 31 may be set within a range of 10 μm to 10 cm, for example.

In a case where the liquid is a specimen liquid in a biochemical test, in particular, it is preferable to perform a blocking treatment, a plasma treatment, or the like for preventing nonspecific adsorption of substances of biological origin, antigens, antibodies, and the like on the surface of the inner flow passage 3 (the microflow passage 31 and the separating flow passage 32) with which the liquid comes into contact. Although a blocking agent used for the blocking treatment includes commercially available blocking agents, bovine serum albumin, casein, skim milk, gelatin, a surfactant, polyvinyl alcohol, globulin, serum (fetal bovine serum or normal rabbit serum, for example), ethanol, an MPC polymer, and the like, and the commercially available blocking agents include ImmunoBlock, Block Ace, Pierce Blocking Buffer, StartingBlock, StabilGuard, StabilBrock, StabilCoat, ChonBlock, and the like, the blocking agent is not limited thereto.

The inner flow passage 3 and the inner ventilation space 7 will be further described.

In the present embodiment, the inner flow passage 3 and the inner ventilation space 7 are formed by an upper flow passage forming member 11, a lower flow passage forming member 12, and an intermediate member 13 functioning as a spacer therebetween being stacked. Hereinafter, the upper flow passage forming member 11, the lower flow passage forming member 12, and the intermediate member 13 will be described in this order.

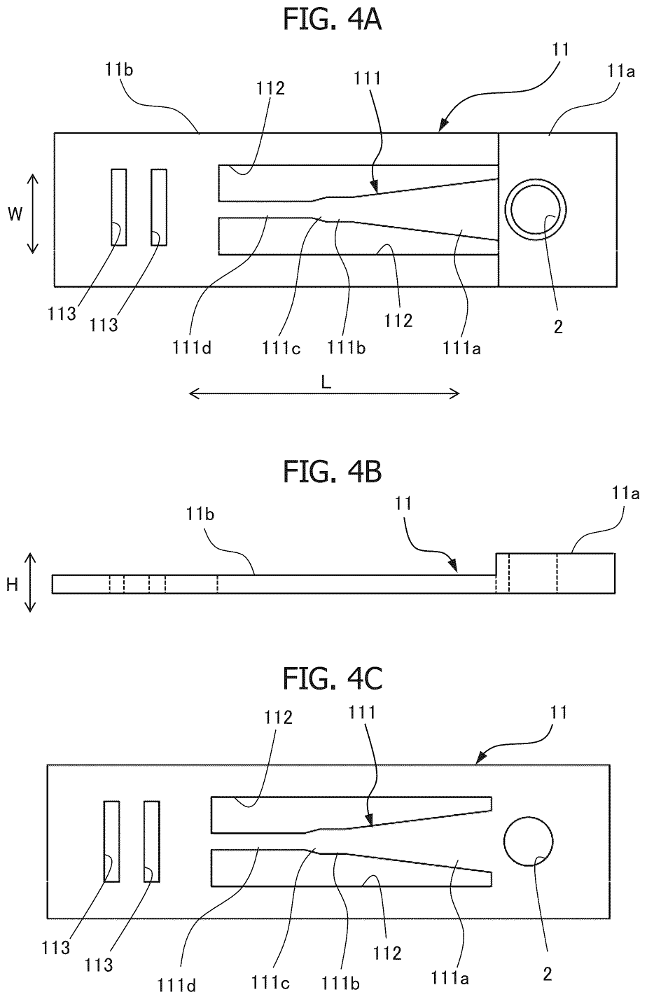

FIGS. 4A to 4C illustrate the upper flow passage forming member 11. FIG. 4A is a top view of the upper flow passage forming member 11, FIG. 4B is a side view of the upper flow passage forming member 11, and FIG. 4C is a bottom view of the upper flow passage forming member 11.

In the present embodiment, the upper flow passage forming member 11 is made of a transparent synthetic resin and is formed to have flexibility to some extent. Preferably, the upper flow passage forming member 11 is configured with a molded article of a transparent synthetic resin. Although examples of such a synthetic resin includes a PS resin (polystyrene), PMMA (acrylic resin), PC (polycarbonate), COP (cycloolefin polymer), COC (cycloolefin copolymer), an ABS resin, an AS resin, and a silicone resin, the synthetic resin is not limited thereto. Also, a contact angle of the surface of the upper flow passage forming member 11 is preferably not more than 90 degrees with respect to water.

Referring to FIGS. 4A to 4C, the upper flow passage forming member 11 has an outer shape formed into a rectangular shape in a top view. Also, the upper flow passage forming member 11 has a larger dimension in the height direction H than the other parts, and in other words, the upper flow passage forming member 11 has a thicker thickness, in a predetermined range at the one side in the longitudinal direction L. Hereinafter, the part with a larger size (the thicker thickness) in the height direction H at the one side in the longitudinal direction L will be referred to as a thick portion 11a, and the remaining part that is thinner than thick portion 11a will be referred to as a thin portion 11b.

The inlet 2 is formed at the thick portion 11a of the upper flow passage forming member 11. The inlet 2 penetrates through the thick portion 11a in the height direction H. In other words, the inlet 2 opens in the upper surface of the thick portion 11a of the upper flow passage forming member 11. The inlet 2 is formed at the center of the width direction W and at a position near the thin portion 11b.

An upper wall portion 111 constituting the upper wall of the inner flow passage 3 along with a part (the peripheral portion of the inlet 2) of the thick portion 11a and a pair of first opening portions 112 and 112 sandwiching the upper wall portion 111 therebetween in the width direction W are formed at the thin portion 11b of the upper flow passage forming member 11. The upper wall portion 111 extends from the vicinity of the inlet 2 toward the other side in the longitudinal direction L. The pair of first opening portions 112 and 112 are symmetrically formed, and extend in the longitudinal direction L along a side edge of the upper wall portion 111 and penetrate through the thin portion 11b of the upper flow passage forming member 11 in the height direction. In other words, the pair of first opening portions 112 and 112 separated from each other in the width direction W and penetrating through in the height direction H are formed at the thin portion 11b of the upper flow passage forming member 11, and the part between the pair of first opening portions 112 and 112 in the thin portion 11b of the upper flow passage forming member 11 constitutes the upper wall portion 111.

In the present embodiment, the upper wall portion 111 includes an upper tapered portion 111a, a first upper straight portion 111b, an upper narrowed width portion 111c, and a second upper straight portion 111d in the order from the one side in the longitudinal direction L, that is, from closest to the inlet 2.

The upper tapered portion 111a is formed to extend from the vicinity of the inlet 2 toward the other side in longitudinal direction L and have a width gradually narrowed (the dimension in width direction W gradually decreases) as it is further separated from the inlet 2.

The first upper straight portion 111b has the same width as the width of the distal end portion of the upper tapered portion 111a and linearly extends from the distal end portion of the upper tapered portion 111a toward the other side in the longitudinal direction L. The width of the first upper straight portion 111b is constant. The distal end portion of the first upper straight portion 111b is located substantially at the center in the longitudinal direction L.

The upper narrowed width portion 111c means a part of the upper wall portion 111 where the width is narrowed. The second upper straight portion 111d is formed to have a narrowed width than the first upper straight portion 111b in the present embodiment. Also, the upper narrowed width portion 111c is formed into a tapered shape in which the width thereof is gradually narrowed from the width of the first upper straight portion 111b to the width of the second upper straight portion 111d, and couples the first upper straight portion 111b to the second upper straight portion 111d. However, the tapered shape is not limited thereto. It is only necessary for the upper narrowed width portion 111c to be a part of the upper wall portion 111 where the width is narrowed, and the upper narrowed width portion 111c may be configured into a shape with steps or a plurality of tapered shapes.

The second upper straight portion 111d is formed to have a narrower width than the first upper straight portion 111b as described above and linearly extends from the upper narrowed width portion 111c toward the other side in the longitudinal direction L. The width of the second upper straight portion 111d is constant.

Also, through-holes 113 and 113 with a rectangular shape that is long in the width direction W are formed at the thin portion 11b of the upper flow passage forming member 11. The through-holes 113 and 113 are provided to be separated from each other in the longitudinal direction L at positions separated from the distal end portion of (the second upper straight portion 111d of) the upper wall portion 111 at the other side in the longitudinal direction L.

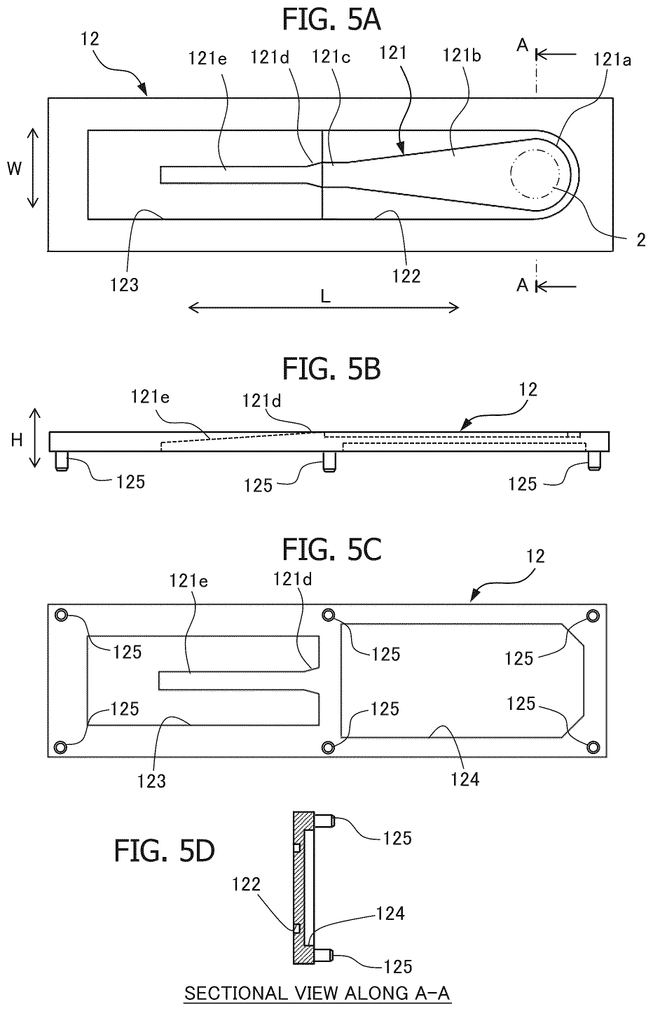

FIGS. 5A to 5D illustrate the lower flow passage forming member 12. FIG. 5A is a top view of the lower flow passage forming member 12, FIG. 5B is a side view of the lower flow passage forming member 12, FIG. 5C is a bottom view of the lower flow passage forming member 12, and FIG. 5D is a sectional view along A-A in FIG. 5A.

In the present embodiment, the lower flow passage forming member 12 is made of a transparent synthetic resin similarly to the upper flow passage forming member 11 and is formed to have flexibility to some extent. Also, the lower flow passage forming member 12 is preferably configured with a molded article of a transparent synthetic resin. Although the lower flow passage forming member 12 is preferably formed by the same synthetic resin as that of the upper flow passage forming member 11, the lower flow passage forming member 12 may be formed by a different synthetic resin. Also, the contact angle of the surface of the lower flow passage forming member 12 is preferably not more than 90 degrees with respect to water.

Referring to FIGS. 5A to 5C, the lower flow passage forming member 12 is formed to have an outer shape with a rectangular shape in a top view so as to correspond to the upper flow passage forming member 11. Also, a lower wall portion 121 constituting the lower wall of the inner flow passage 3 is formed at the lower flow passage forming member 12 so as to correspond to the inlet 2 and the upper wall portion 111 formed at the upper flow passage forming member 11. In other words, the lower wall portion 121 is formed to be located below the inlet 2 and the upper wall portion 111 in the upper flow passage forming member 11 when the upper flow passage forming member 11, the lower flow passage forming member 12, and the intermediate member 13 are stacked. The lower wall portion 121 extends from the one side toward the other side in the longitudinal direction L similarly to the upper wall portion 111.

In the present embodiment, the lower wall portion 121 includes a semicircular portion 121a, a lower tapered portion 121b, a first lower straight portion 121c, a lower narrowed width portion 121d, and a second lower straight portion 121e in this order from the one side in the longitudinal direction L.

The semicircular portion 121a is a part corresponding to the inlet 2 of the upper flow passage forming member 11. The semicircular portion 121a is concentric with the inlet 2 of the upper flow passage forming member 11 illustrated by the two-dotted chain line in FIG. 5A and has a larger diameter than the inlet 2.

The lower tapered portion 121b is a part corresponding to the upper tapered portion 111a of the upper flow passage forming member 11. The lower tapered portion 121b is formed to extend from the semicircular portion 121a toward the other side in longitudinal direction L and have a width gradually narrowed as it is further separated from the semicircular portion 121a. The gradient of the lower tapered portion 121b is set to be the same as the gradient of the upper tapered portion 111a.

The first lower straight portion 121c is a part corresponding to the first upper straight portion 111b of the upper flow passage forming member 11. The first lower straight portion 121c has the same width as that of the distal end portion of the lower tapered portion 121b and linearly extends from the distal end portion of the lower tapered portion 121b toward the other side in the longitudinal direction L. The first lower straight portion 121c has the same width as that of the first upper straight portion 111b.

Here, in the present embodiment, a recessed groove portion 122 with a substantially U shape having an open portion facing the other end is formed in an upper surface closer to the one side than the center portion of the lower flow passage forming member 12 in longitudinal direction L, and an inner part of the recessed groove portion 122 in the lower flow passage forming member 12 constitutes the semicircular portion 121a, the lower tapered portion 121b, and the first lower straight portion 121c.

The lower narrowed width portion 121d refers to a part corresponding to the upper narrowed width portion 111c of the upper flow passage forming member 11 and a part where the width of the lower wall portion 121 is narrowed. The second lower straight portion 121e is formed to have a narrower width than the first lower straight portion 121c and the same width as that of the second upper straight portion 111d of the upper flow passage forming member 11 in the present embodiment. Also, the lower narrowed width portion 121d is formed into a tapered shape in which the width is gradually narrowed from the width of the first lower straight portion 121c to the width of the second lower straight portion 121e, and couples the first lower straight portion 121c to the second lower straight portion 121e. Note that in a case where the upper narrowed width portion 111c is configured to have a shape with steps or a plurality of tapered shapes, for example, the lower narrowed width portion 121d is also configured to have a shape with steps or a plurality of tapered shapes accordingly.

The second lower straight portion 121e is a part corresponding to the second upper straight portion 111d of the upper flow passage forming member 11. The second lower straight portion 121e is formed to have a narrower width (with the same width as that of the second upper straight portion 111d) than the first lower straight portion 121c and linearly extends from the lower narrowed width portion 121d toward the other side in the longitudinal direction L.

Here, a bored hole 123 with a substantially U shape having an open portion facing the one side is formed on the side closer to the other side than the center of the lower flow passage forming member 12 in the longitudinal direction L, and the inner part of the bored hole 123 in the lower flow passage forming member 12 constitutes the lower narrowed width portion 121d and the second lower straight portion 121e. Note that the upper surfaces of the lower narrowed width portion 121d and the second lower straight portion 121e are inclined such that the height positions thereof are gradually lowered at a greater distance from the distal end portion of the first lower straight portion 121c. Also, a part of the bored hole 123 on the other side in longitudinal direction L constitutes the accommodating space 5 in which the first liquid absorbing material 4 is accommodated.

Also, a recessed portion 124 is formed in a lower surface on the side closer to the one side than the center of the lower flow passage forming member 12 in the longitudinal direction L. The recessed portion 124 has a size with which it includes at least a most part of the lower tapered portion 121b of the lower wall portion 121 in a top view. A back plate 15, which will be described later, is housed in recessed portion 124.

Furthermore, a plurality of (six here) pins 125 are provided to project at intervals therebetween in a peripheral edge portion of the lower surface of the lower flow passage forming member 12. Note that although six pins 125 are provided here, the number of the pins 125 may be freely set.

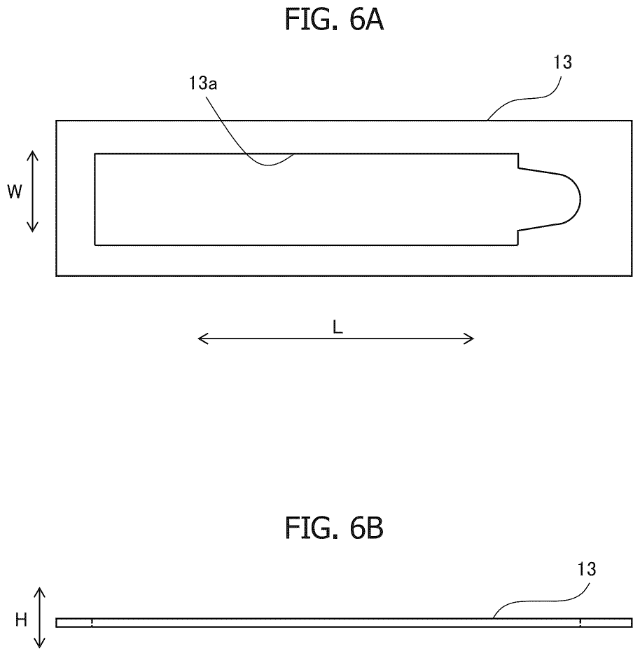

FIGS. 6A and 6B illustrate the intermediate member 13. FIG. 6A is a top view of the intermediate member 13, and FIG. 6B is a side view of the intermediate member 13.

Referring to FIGS. 6A and 6B, the intermediate member 13 is formed to have a rectangular outer shape in a top view so as to correspond to the upper flow passage forming member 11 and the lower flow passage forming member 12. The intermediate member 13 has a small dimension in the height direction H (that is, the thickness) and has a second opening portion 13a that penetrates through in the height direction H therein. The dimension (the thickness) of the intermediate member 13 in the height direction His set in accordance with the required height of the microflow passage 31. The second opening portion 13a has a size with which it includes the inlet 2, the upper wall portion 111, the pair of first opening portions 112 and 112, and the through-holes 113 and 113 formed in the upper flow passage forming member 11 therein in a top view.

Also, the upper surface and the lower surface of the intermediate member 13 are formed as members with adhesiveness. In one example, the intermediate member 13 may be formed by disposing double-sided adhesive sheets on an upper surface and a lower surface of a sheet material. In this case, it is possible to freely change the dimension of the intermediate member 13 in the height direction H, that is, the height of the microflow passage 31 by appropriately selecting the sheet material with any thickness, for example. Also, the intermediate member 13 may be any intermediate member as long as a liquid does not penetrate into at least a part functioning as a spacer (spacer portion), and it is also possible to freely change the shape and the type of the intermediate member 13.

Also, the upper flow passage forming member 11, the lower flow passage forming member 12, and the intermediate member 13 are stacked and integrated by the lower surface of the upper flow passage forming member 11 being joined to the upper surface of the intermediate member 13 and by the upper surface of the lower flow passage forming member 12 being joined to the lower surface of the intermediate member 13. The inner flow passage 3 and the inner ventilation space 7 are thereby formed. Here, the lower absorbing material 4b of the first liquid absorbing material 4 is accommodated at a predetermined position (in the accommodating space 5) of the bored hole 123 in the lower flow passage forming member 12, and the upper absorbing material 4a is further placed on the lower absorbing material 4b before the upper flow passage forming member 11, the lower flow passage forming member 12, and the intermediate member 13 are integrated in actual assembly.

Note that the aforementioned flow passage surface changing portion is at least partially mounted on the upper absorbing material 4a. Specifically, barrier forming members 410a and 410b that function as the flow passage surface changing portions that provide changes in the surface of the separating flow passage 32 are mounted on the upper surface and the lower surface of the upper absorbing material 4a, respectively. In this manner, the upper absorbing material 4a with the barrier forming members 410a and 410b mounted thereon is disposed on the lower absorbing material 4b accommodated in the accommodating space 5.

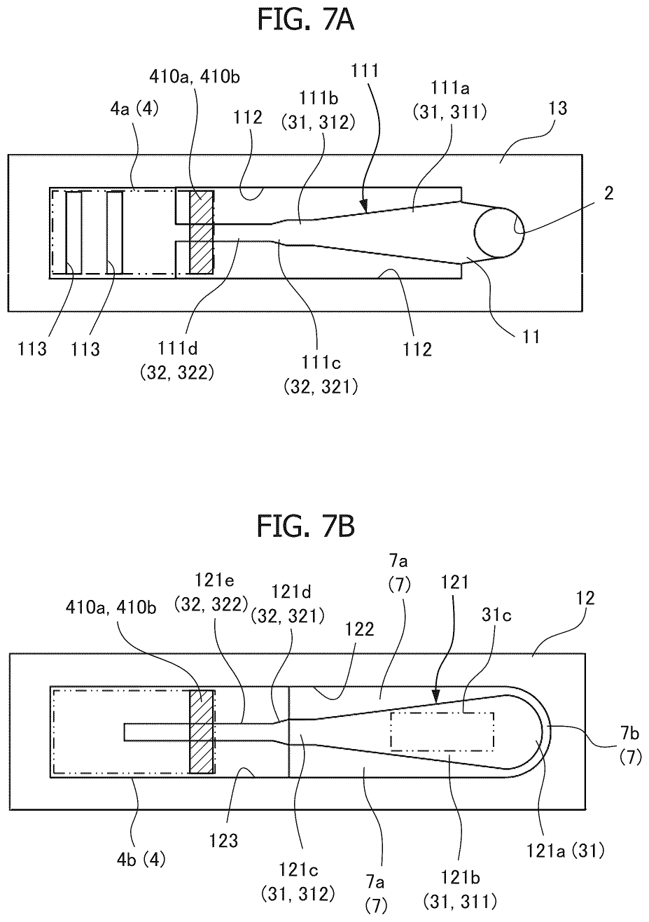

FIGS. 7A and 7B are diagrams for explaining the inner flow passage 3 and the inner ventilation space 7. FIG. 7A is a diagram of the upper flow passage forming member 11 and the intermediate member 13 seen from the side of the lower flow passage forming member 12 and mainly illustrates an upper portion of the inner flow passage 3. FIG. 7B is a diagram of the lower flow passage forming member 12 from the side of the intermediate member 13 and mainly illustrates a lower portion of the inner flow passage 3. Note that the two-dotted chain lines in the drawings indicate the first liquid absorbing material 4 (the upper absorbing material 4a, the lower absorbing material 4b), and the barrier forming members 410a and 410b disposed on the upper absorbing material 4a are illustrated by hatching.

In the present embodiment, the upper tapered portion 111a and the first upper straight portion 111b of the upper wall portion 111 of the upper flow passage forming member 11 constitute the upper wall of the microflow passage 31 in the inner flow passage 3, and the semicircular portion 121a, the lower tapered portion 121b, and the first lower straight portion 121c of the lower wall portion 121 of the lower flow passage forming member 12 constitute the lower wall of the microflow passage 31 in the inner flow passage 3. Moreover, the upper narrowed width portion 111c and the second upper straight portion 111d of the upper wall portion 111 of the upper flow passage forming member 11 constitute the upper wall of the separating flow passage 32 in the inner flow passage 3, and the lower narrowed width portion 121d and the second lower straight portion 121e of the lower wall portion 121 of the lower flow passage forming member 12 constitute the lower wall of the separating flow passage 32 in the inner flow passage 3.

In other words, the microflow passage 31 is formed as a flow passage including a tapered flow passage portion 311 that extends from the vicinity of the inlet 2 toward the separating flow passage 32, with a flow passage width gradually narrowed as it is further separated from the inlet 2, and a first straight flow passage portion 312 that extends from the distal end portion of the tapered flow passage portion 311, and reaches the separating flow passage 32 with a constant flow passage width. Note that although not particularly limited, the flow passage width near an entrance of the microflow passage 31 (that is, in the vicinity of the inlet 2) may be equal to or greater than 2 mm and equal to or less than 10 mm, for example, and the flow passage width near an exit of the microflow passage 31 (that is, in the vicinity of the separating flow passage 32) may be equal to or greater than 1 mm and equal to or less than 6 mm, for example.

Also, the separating flow passage 32 is formed as a flow passage including a narrowed width portion 321 that is formed as a flow passage extending from the microflow passage 31 toward the first liquid absorbing material 4 with a narrowed flow passage width, and a second straight flow passage portion 322 that extends from the narrowed width portion 321, and reaches the first liquid absorbing material 4 with a narrower flow passage width than the first straight flow passage portion 312. Also, the narrowed width portion 321 is formed into a tapered shape with a flow passage width gradually narrowed from the flow passage width of the first straight flow passage portion 312 of the microflow passage 31 to the flow passage width of the second straight flow passage portion 322. Also, the lower wall of the separating flow passage 32 is inclined downward such that the height position is lowered toward the first liquid absorbing material 4. Note that although not particularly limited, the flow passage width near the exit of the narrowed width portion 321 may be equal to or greater than 0.5 mm and equal to or less than 5 mm, for example.

The barrier forming members 410a and 410b are disposed in the second straight flow passage portion 322 of the separating flow passage 32. Specifically, the barrier forming members 410a and 410b are disposed at positions corresponding to the end portion of the first liquid absorbing material 4 on the upstream side in the flowing direction of the liquid.

Furthermore, the inner ventilation space 7 (the sideways spaces 7a and 7a and the coupling space 7b) are formed by the recessed groove portion 122 with a substantially U shape formed in the upper surface on the side closer to the one side than the center of the lower flow passage forming member 12 in the longitudinal direction L and a space above the recessed groove portion 122. Also, the pair of first opening portions 112 and 112 formed in the upper flow passage forming member 11 are located above the sideways spaces 7a and 7a of the inner ventilation space 7 and communicate with the sideways spaces 7a and 7a.

Here, the barrier forming members 410a and 410b will be described. The barrier forming members 410a and 410b are members provided to promote separation of the liquid on the upstream side of the first liquid absorbing material 4 and are configured to function as the flow passage surface changing portion that provides a change in the surface of the separating flow passage 32 with which the liquid comes into contact as described above. In the present embodiment, the barrier forming members 410a and 410b are members to promote separation of the liquid and can thus be regarded as parts constituting the separating flow passage 32 although the barrier forming members 410a and 410b are mounted on the first liquid absorbing material 4.

A stepped structure projecting from the upper passage forming member 11 and the lower passage forming member 12 to inside of the separating flow passage 32 is substantially formed by mounting the barrier forming members 410a and 410b on the first liquid absorbing material 4. In other words, the surface of the separating flow passage 32 with which the liquid comes into contact changes, that is, the dimension of the separating flow passage 32 in height direction H locally changes by mounting the barrier forming members 410a and 410b. The barrier forming member 410a is disposed on one side of the upper absorbing material 4a of the first liquid absorbing material 4, that is, on the upper surface of the end portion on the upstream side, while the barrier forming member 410b is disposed on one side of the upper absorbing agent 4a, that is, on the lower surface of the end portion on the upstream side.

In an example, the barrier forming members 410a and 410b may be formed by disposing double-sided adhesive sheets or the like on an upper surface and a lower surface of a sheet material, respectively. It is possible to set the dimensions of the barrier forming materials 410a and 410b in height direction H to desired dimensions by appropriately selecting the sheet material with any thickness. Although the sheet material is made of a hydrophobic material that does not allow the liquid to penetrate therethrough and can be formed of polyethylene terephthalate (PET) or glass, for example, the material is not limited thereto. The barrier forming members 410a and 410b are attached to the upper surface and the lower surface of the upper absorbing material 4a via the double-sided adhesive sheets, respectively.

The upper absorbing material 4a is formed of a flexible porous material such as cotton, for example, the barrier forming members 410a and 410b are thus disposed to sink in the upper absorbing material 4a when the barrier forming members 410a and 410b are mounted on the upper surface and the lower surface of the upper absorbing material 4a, respectively, and the upper flow passage forming member 11, the lower flow passage forming member 12, and the intermediate member 13 are integrated.

Here, although the shape of the barrier forming members 410a and 410b are not particularly limited, the shapes can be a rectangular parallelepiped shape, for example. The thickness (the dimension in height direction H) of the barrier forming members 410a and 410b is set in accordance with the height of the separating flow passage 32, a composition of the liquid to be injected into the assay device 1, and the like to promote division of the liquid. Although not particularly limited, each of the thicknesses of the barrier forming members 410a and 410b can be set within a range of 1 μm to 1000 μm, for example. Although it is desirable that the width (the dimension in width direction W) of the barrier forming members 410a and 410b be equivalent to or be equal to or greater than the flow passage width, the width of the barrier forming members 410a and 410b is not particularly limited. Moreover, the length (the dimension in longitudinal direction L) of the barrier forming members 410a and 410b is set in accordance with the dimension of the first liquid absorbing material 4, the dimension of the separating flow passage 32, and the composition of the liquid to be injected into the assay device 1, for example, to promote division of the liquid. Although not particularly limited, the length of each of the barrier forming members 410a and 410b may be set within a range of 0.1 mm to 100 mm, for example.

Note that although the barrier forming member 410a is mounted on the upper surface of the upper absorbing material 4a, and the barrier forming member 410b is mounted on the lower surface of the upper absorbing material 4a in the present embodiment, a configuration in which only any one of them is mounted. Whether to mount both the barrier forming members 410a and 410b or to mount only any one of the barrier forming members 410a and 410b can be appropriately set in accordance with the thickness of the barrier forming members, the height of the separating flow passage 32, the composition of the liquid to be injected into the assay device 1, and the like. Since the upper absorbing material 4a is formed of a flexible porous material, additional members, working, and the like accompanying the mounting of the barrier forming members are not needed even if the number and dimensions of the barrier forming members are changed in accordance with the composition of the liquid and the like.

Next, other configurations of the assay device 1 will be described with reference to FIGS. 1 to 3.

The assay device 1 further includes an upper cover 14, the back plate 15, a second liquid absorbing material 16, and a lower case 17 in addition to the first liquid absorbing material 4 (the upper absorbing material 4a and the lower absorbing material 4b), the upper flow passage forming member 11, the lower flow passage forming member 12, and the intermediate member 13 described above.

The upper cover 14 is made of a synthetic resin, for example, and is formed into a flat plate shape. Preferably, the upper cover 14 is configured with a molded article of a synthetic resin. The upper cover 14 is attached (adhered) to the upper surface of (the thin portion 11b of) the upper flow passage forming member 11 via a double-sided adhesive sheet 18 formed into substantially the same shape as that of the upper cover 14.

The ventilation holes 141 and 141 that cause the inner ventilation space 7 to communicate with the outside are formed in the upper cover 14. The ventilation holes 141 and 141 are disposed above the pair of first opening portions 112 and 112 in the upper flow passage forming member 11 communicating with the inner ventilation space 7 (the sideways spaces 7a and 7a).

Also, observation windows 142 and 142 for an observer to observe (a detectable result occurring in) the assay region 31c in the microflow passage 31 are formed in the upper cover 14. The observation windows 142 and 142 are disposed above the assay region 31c in the microflow passage 31, more specifically, above the first assay reagent 6a and the second assay reagent 6b.

Furthermore, checking/ventilation windows 143 and 143 for causing the accommodating space 5 that accommodates the first liquid absorbing material 4 to communicate with the outside and for checking a state (such as a liquid absorbing condition) of the first liquid absorbing material 4 are formed in the upper cover 14. The checking/ventilation windows 143 and 143 are disposed above the first liquid absorbing material 4 and above two through-holes 113 and 113 in the upper flow passage forming member 11.

The back plate 15 is made of a white or black synthetic resin and is preferably configured with a molded article of a synthetic resin. The back plate 15 is housed in the recessed portion 124 formed in the lower surface of the lower flow passage forming member 12. As described above, the upper flow passage forming member 11 and the lower flow passage forming member 12 forming the inner flow passage 3 are formed to be transparent in the present embodiment. Also, the recessed portion 124 formed in the lower surface of the lower flow passage forming member 12 has a size with which a most part of the lower tapered portion 121b of the lower wall portion 121 constituting the lower wall of the microflow passage 31 is included therein. Therefore, the back plate 15 is disposed below the assay region 31c of the microflow passage 31 by being housed in the recessed portion 124 formed in the lower surface of the lower flow passage forming member 12. Also, the back plate 15 housed in the recessed portion 124 provides a white or black background to the assay region 31c to thereby make it easier for the observer to observe (the detectable result occurring in) the assay region 31c through the observation windows 142 and 142.

Therefore, the color of the back plate 15 is preferably appropriately selected in accordance with the detectable result to occur in the assay region 31c. For example, a white back plate 15 is selected in a case where it is necessary for the observer to observe coloring, light absorbance, and the like through the observation windows 142 and 142, or a black back plate 15 is selected in a case where it is necessary for the observer to observe light emission, fluorescence, and the like through the observation windows 142 and 142.

The second liquid absorbing material 16 is formed by a porous material capable of absorbing a liquid similarly to the first liquid absorbing material 4. The second liquid absorbing material 16 is formed to be larger than the first liquid absorbing material 4 and is disposed below the first liquid absorbing material 4 and the lower flow passage forming member 12. The second liquid absorbing material 16 mainly absorbs the liquid via the first liquid absorbing material 4.

The lower case 17 is made of a synthetic resin, for example, and is preferably configured with a molded article of a synthetic resin. The lower case 17 includes an accommodating portion 171 of an upper surface opening for housing the second liquid absorbing material 16 and a support surface 172 that supports the lower surface of the back plate 15 housed in the recessed portion 124 formed in the lower surface of the lower flow passage forming member 12. Also, six pin holes 173 into which six pins 125 provided to project from the lower surface of the lower flow passage forming member 12 are fitted are formed at a peripheral edge portion of the upper surface of the lower case 17.

The assay device 1 illustrated in FIG. 1 is obtained by each member (component) illustrated in FIG. 3 being assembled.

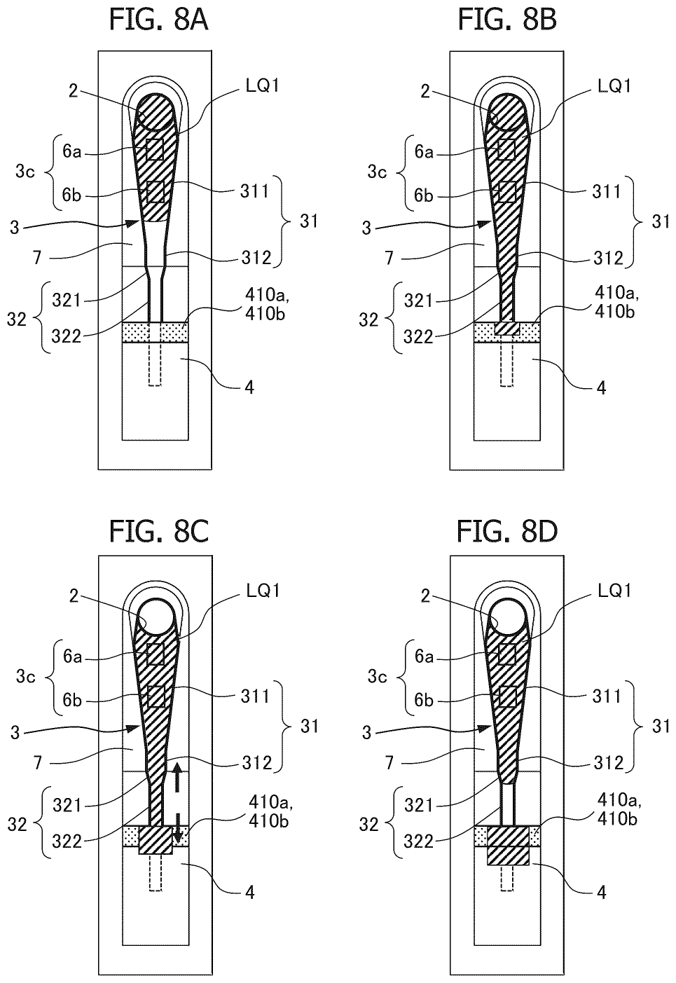

Next, movement of the liquid in the assay device 1 will be described with reference to FIGS. 8A to 10F.

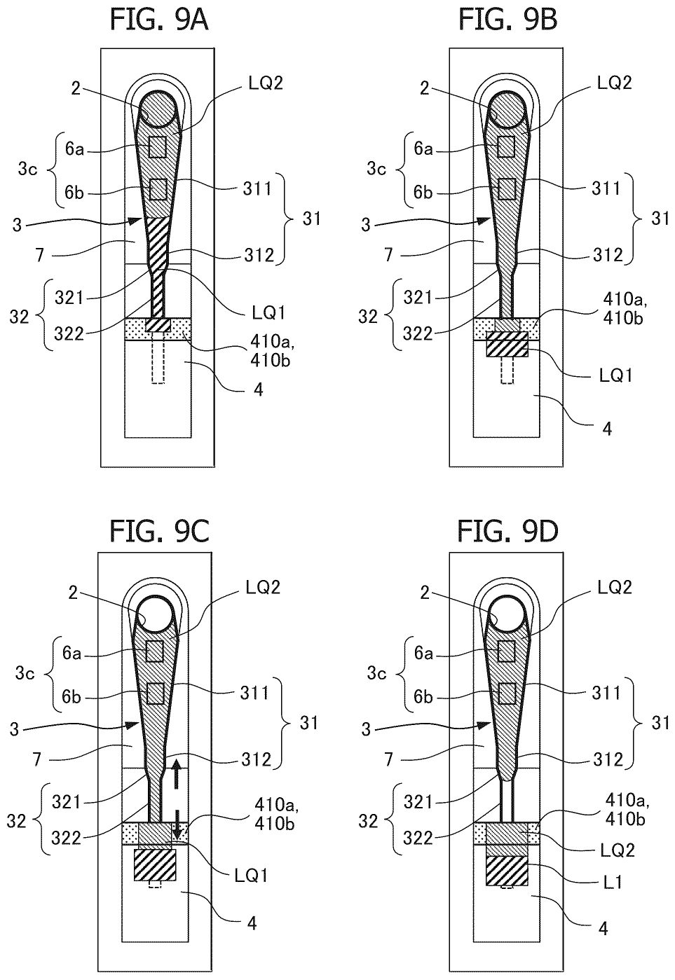

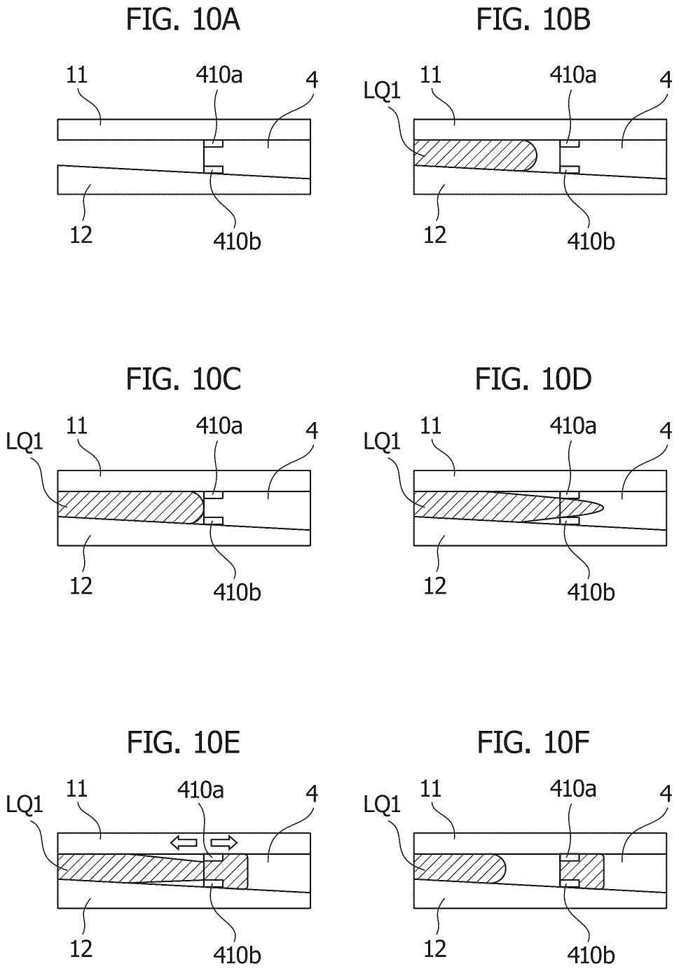

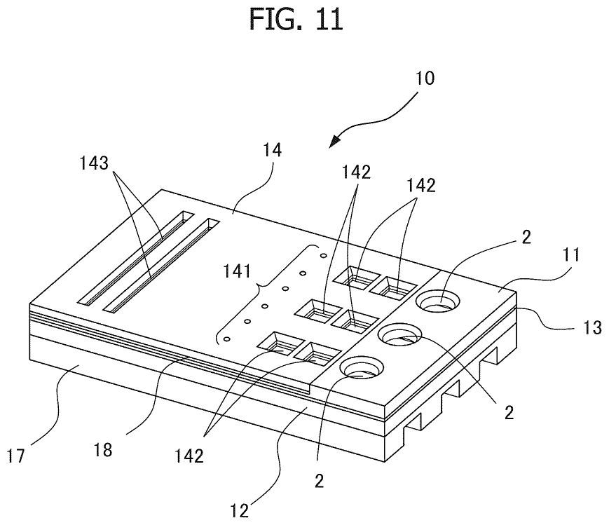

FIGS. 8A to 8D are diagrams for explaining movement of a liquid (hereinafter, referred to as a “first liquid LQ1”) injected into the assay device 1, and FIGS. 9A to 9D are diagrams for explaining movement of a liquid (hereinafter, referred to as a “second liquid LQ2”) injected into the assay device 1 and schematically illustrate the inner flow passage 3 and the like when the assay device 1 is seen from above. Note that in FIGS. 8A to 8D and 9A to 9D, the first liquid LQ1 and the second liquid LQ2 are illustrated by hatching. FIGS. 10A to 10F are schematic sectional views of a boundary region between the separating flow passage 32 and the first liquid absorbing material 4 and illustrate a state in which the liquid is divided on the upstream side of the first liquid absorbing material 4. FIG. 10A illustrates a state before the liquid reaches the separating flow passage 32.

Once the first liquid LQ1 is injected from the inlet 2, the first liquid LQ1 enters (is supplied to) the microflow passage 31 as illustrated in FIG. 8A. The first liquid LQ1 that has entered the microflow passage 31 smoothly flows toward the separating flow passage 32.

When the injection of the first liquid LQ1 is continued, and the first liquid LQ1 in amount exceeding the capacity of microflow passage 31 is supplied to the microflow passage 31, the first liquid LQ1 flows into the separating flow passage 32. Here, the lower wall of the separating flow passage 32 is inclined downward such that the height position is lowered as it approaches the first liquid absorbing material 4 as illustrated in FIG. 10B. Therefore, the first liquid LQ1 that has flowed into the separating flow passage 32 flows through the separating flow passage 32 toward the first liquid absorbing material 4 and comes into contact with the first liquid absorbing material 4 as illustrated in FIG. 8B. Then, the first liquid LQ1 is absorbed by the first liquid absorbing material 4 due to a capillary force of the first liquid absorbing material 4.

At this time, the first liquid LQ1 smoothly flowing through the separating flow passage 32 inclined downward passes through the barrier forming members 410a and 410b, comes into contact with the first liquid absorbing material 4, and is then absorbed as illustrated in FIGS. 10C and 10D.

Thereafter, once the injection of first liquid LQ1 is stopped, the first liquid LQ1 in the inlet 2 flows toward the first liquid absorbing material 4, and the flowing of the first liquid LQ1 inside the microflow passage 31 into the separating flow passage 32 is then stopped. At this time, since the capillary force of the first liquid absorbing material 4 acts on the first liquid LQ1, a state where the first liquid LQ1 is pulled between the microflow passage 31 and the first liquid absorbing material 4 is achieved as illustrated by the arrow in FIGS. 8C and 10E.

Here, the barrier forming members 410a and 410b that function as the flow passage surface changing portions that provide changes in the surface of the separating flow passage 32 are provided in the separating flow passage 32 located between the microflow passage 31 and the first liquid absorbing material 4 in the present embodiment. The first liquid LQ1 is pulled on one side (upstream side) by an interfacial tension of the liquid inside the microflow passage 31 and is pulled on the other side (downstream side) by a capillary force of the first liquid absorbing material 4, a change occurs in the flow passage surface with which the first liquid LQ1 comes into contact due to presence of the barrier forming members 410a and 410b, and the first liquid LQ1 becomes likely to be divided to the upstream side and to the downstream side. The separating flow passage 32 further includes the narrowed width portion 321 with a narrowed flow passage width. Therefore, the first liquid LQ1 inside the microflow passage 31 on the upstream side of the narrowed width portion 321 is urged to stay in the microflow passage 31 due to an interfacial tension, and flowing of the first liquid LQ1 inside the microflow passage 31 across the narrowed width portion 321 to the downstream side is inhibited. On the other hand, the first liquid LQ1 on the downstream side of the narrowed width portion 321 is suctioned due to the capillary force of the first liquid absorbing material 4.

As a result, the first liquid LQ1 inside the inner flow passage 3 is divided on the upstream side of the first liquid absorbing material 4. In this manner, a part (a part located on the downstream side of the narrowed width portion 321) of the first liquid LQ1 is absorbed by the first liquid absorbing material 4, while the rest is left on the upstream side of the narrowed width portion 321, that is, mainly inside the microflow passage 31 as illustrated in FIGS. 8D and 10F. In this manner, the first liquid LQ1 inside the inner flow passage 3 is separated into a part absorbed by the first liquid absorbing material 4 and a part left inside the microflow passage 31.

In this manner, since the barrier forming members 410a and 410b that function as the flow passage surface changing portions is provided in the separating flow passage 32 and the narrowed width portion 321 is further provided in the present embodiment, even the first liquid LQ1 with low (weak) interfacial tension is not suctioned from the microflow passage 31 to the first liquid absorbing material 4 due to the capillary force of the first liquid absorbing material 4.

As a result, it is possible to stably divide the first liquid LQ1 inside the inner flow passage 3 by the separating flow passage 32, in other words, it is possible to cause the first liquid LQ1 to stably stay inside the microflow passage 31. Then, as the first liquid LQ1 stays inside the assay region 31c, the detectable result occurs by the first assay reagent 6a and/or the second assay reagent 6b reacting with the first liquid LQ1 or a specimen contained therein. In other words, an assay is performed in the first liquid LQ1 staying inside the assay region 31c and assay region 31c.

FIGS. 9A to 9D are diagrams for explaining motion of the first liquid LQ1 and a new liquid (hereinafter, referred to as a “second liquid LQ2”) when the second liquid LQ2 is injected after the injection of the first liquid LQ1 into the assay device 1 is stopped, and schematically illustrates the inner flow passage 3 and the like when the assay device 1 is seen from above. In FIGS. 9A to 9D, the first liquid LQ1 is hatched in the same manner as in FIGS. 8A to 8D, and the second liquid LQ2 is hatched differently from the first liquid LQ1.

Once the second liquid LQ2 is injected after the injection of the first liquid LQ1 is stopped, the second liquid LQ2 enters (is supplied to) the microflow passage 31 and flows toward the separating flow passage 32 similarly to the case of the first liquid LQ1 as illustrated in FIG. 9A. Here, although the first liquid LQ1 is left inside the microflow passage 31 as described above, the first liquid LQ1 left inside the microflow passage 31 is pushed out of the microflow passage 31 by the newly injected second liquid LQ2, flows through the separating flow passage 32, comes into contact with the first liquid absorbing material 4, and is absorbed by the first liquid absorbing material 4.

When the injection of the second liquid LQ2 is continued, and the second liquid LQ2 in amount exceeding the volume of the microflow passage 31, in other words, the second liquid LQ2 in amount exceeding the amount of the first liquid LQ1 left inside the microflow passage 31 is supplied to the microflow passage 31, all the first liquid LQ1 left inside the microflow passage 31 is pushed out of the microflow passage 31. As a result, the first liquid LQ1 is replaced with the second liquid LQ2 inside the microflow passage 31. In other words, liquid replacement is performed inside the microflow passage 31. Then, when the second liquid LQ2 is further injected, the second liquid LQ2 flows from the microflow passage 31 into the separating flow passage 32, and the second liquid LQ2 flows through the separating flow passage 32 toward the first liquid absorbing material 4 and comes into contact with the first liquid absorbing material 4. In this manner, the second liquid LQ2 is absorbed by the first liquid absorbing material 4 due to the capillary force of the first liquid absorbing material 4 subsequently from the first liquid LQ1.

Thereafter, once the injection of the second liquid LQ2 is stopped, the second liquid LQ2 in the inlet 2 flows toward the first liquid absorbing material 4, and the flowing of the second liquid LQ2 inside the microflow passage 31 into the separating flow passage 32 is then stopped. At this time, since the capillary force of first liquid absorbing material 4 acts on the second liquid LQ2, a state where the second liquid LQ2 is pulled between the microflow passage 31 and the first liquid absorbing material 4 is achieved similarly to the case of the first liquid LQ1 as illustrated in FIG. 9C.

Then, division of the second liquid LQ2 on the upstream side of the first liquid absorbing material 4 is promoted due to presence of the barrier forming members 410a and 410b, and the second liquid LQ2 located on the downstream side of the narrowed width portion 321 is suctioned due to the capillary force of the first liquid absorbing material 4, similarly to the case of the first liquid LQ1. On the other hand, the second liquid LQ2 inside the microflow passage 31 on the upstream side of the narrowed width portion 321 is urged to stay in the microflow passage 31 due to the interfacial tension, and the flowing of the second liquid LQ2 inside the microflow passage 31 across the narrowed width portion 321 toward the downstream side is inhibited similarly to the case of the first liquid LQ1.

In this manner, the second liquid LQ2 inside the inner flow passage 3 is divided on the upstream side of the first liquid absorbing material 4, a part thereof (the part located on the downstream side of the narrowed width portion 321) is absorbed by the first liquid absorbing material 4, and the rest is left on the upstream side of the narrowed width portion 321, that is, mainly inside the microflow passage 31. Also, an assay is performed in the assay region 31c similarly to the case of the first liquid LQ1 by the second liquid LQ2 staying inside the microflow passage 31.

Although the interfacial tension also acts on the liquid when the liquid inside the microflow passage 31 is absorbed by the first liquid absorbing material 4 as described above, the part on which the interfacial tension hardly acts, that is, the part near the boundary between the other end portion of the separating flow passage 32 and the first liquid absorbing material 4, is likely to get disconnected. Since the flow passage surface changing portions 410a and 410b are provided near the boundary between the other end portion of the separating flow passage 32 and the first liquid absorbing material 4 on which the interfacial tension hardly acts, the liquid is effectively separated at this part. In this manner, according to the assay device 1, even the liquid with a small (weak) interfacial tension inside the inner flow passage 3 can be stably divided at the separating flow passage 32 and can be stably left inside the microflow passage 31 after injection of the liquid is stopped. Liquid replacement is performed inside the microflow passage 31 by the new liquid (the second liquid LQ2, for example) being injected in amount exceeding the amount of liquid (the first liquid LQ1, for example) left inside the microflow passage 31 in the state where the liquid (the first liquid LQ1, for example) is left inside the microflow passage 31. In other words, it is possible to stably perform liquid replacement inside the microflow passage 31 even in the case of a liquid with a small (weak) interfacial tension according to the assay device 1. Also, such stable liquid replacement can facilitate causing of an antigen-antibody reaction in multiple stages by the ELISA method or the like. While it is possible to further effectively divide the liquid by the narrowed width portion 321 being provided in the separating flow passage 32 in the assay device 1, the narrowed width portion 321 is not essential, and a configuration in which the separating flow passage 32 does not include the narrowed width portion 321 may also be employed.

The assay device 1 according to the present embodiment described above can exhibit effects and advantages as follows.

The assay device 1 includes: the inlet 2; the inner flow passage 3 through which the liquid injected from the inlet 2 flows; and the first liquid absorbing material 4 that absorbs the liquid that has passed through the inner flow passage 3. The inner flow passage 3 includes the microflow passage 31 that includes the assay region 31c and the separating flow passage 32 that is provided between the microflow passage 31 and the first liquid absorbing material 4 for separating the liquid inside the inner flow passage 3 into a part that is left in the microflow passage 31 and a part that is absorbed by the first liquid absorbing material 4 when injection of the liquid is stopped, and the separating flow passage 32 includes the barrier forming members 410a and 410a as a flow passage surface changing portion that provides a change in a surface of the separating flow passage 32 with which the liquid comes into contact.

In the assay device 1, a state where the liquid is pulled between the microflow passage 31 and the first liquid absorbing material 4 is achieved after the liquid of the inlet 2 flows toward the first liquid absorbing material 4 once the injection of the liquid is stopped (see FIGS. 8C and 10E). At this time, the liquid inside the microflow passage 31 strongly tries to stay inside the microflow passage 31 due to its own interfacial tension. The flow of the liquid is likely to be divided due to the presence of the flow passage surface changing portions 410a and 410b, the liquid inside the inner flow passage 3 is stably divided on the downstream side of the separating flow passage 32, that is, on the upstream side of the first liquid absorbing material 4 even in a case where the interfacial tension is small, and it is possible for the liquid to stably stay within the microflow passage 31. Therefore, there is substantially no possibility that air is mixed into the microflow passage 31, replacement of the liquid inside the microflow passage 31 is stably performed, and the assay inside the microflow passage 31 can thus stably advance.

The flow passage surface changing portions 410a and 410b include the stepped structure that provides a step to the separating flow passage 32, and it is thus possible to promote division of the liquid by the step.

The stepped structure of the flow passage surface changing portion is formed from the material that does not allow the liquid to penetrate therethrough, and includes the barrier forming members 410a and 410b mounted on the end portion of the first liquid absorbing material 4 on the upstream side in the flowing direction of the liquid, and it is thus possible to simply form the stepped structure.

The barrier forming members 410a and 410b are mounted on at least one of the upper surface and the lower surface of the first liquid absorbing material 4 in accordance with the height of the separating flow passage 32, the composition of the liquid that is injected into the assay device 1, and the like to promote division of the liquid.

### Second Embodiment

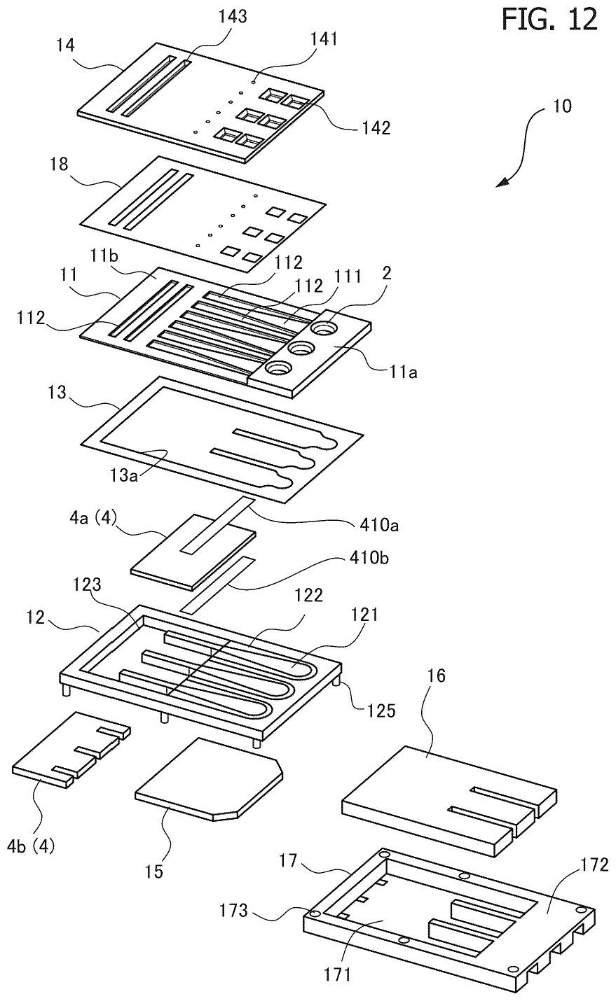

FIGS. 11 and 12 illustrate an assay device 10 according to a second embodiment. FIG. 11 is a perspective view of the assay device 10, and FIG. 12 is an exploded perspective view of the assay device 10. Note that elements in FIGS. 11 and 12 common to those in the assay device 1 according to the first embodiment will be denoted by the same reference signs and description thereof will be omitted.

Main differences between the assay device 1 according to the first embodiment and the assay device 10 according to the second embodiment are that while one inlet 2 and one inner flow passage 3 are provided in the assay device 1 according to the first embodiment, a plurality of (three here) inlets 2 and a plurality of inner flow passages 3 are provided in the assay device 10 according to the second embodiment, and the numbers of ventilation holes 141, observation windows 142, and the like provided are also increased accordingly.

In addition, the first liquid absorbing material 4 is disposed to absorb the liquid that has passed through the plurality of inner flow passages 3, and the barrier forming members 410a and 410b that function as the flow passage surface changing portion that provides a change in the surface of the separating flow passage 32 with which the liquid comes into contact are mounted on at least one of the upper surface and the lower surface of the end portion of the upper absorbing material 4a on the upstream side. The dimension of the barrier forming members 410a and 410b in width direction W is substantially the same as the dimension of the upper absorbing material 4a in width direction W. Configurations other than the above configurations are basically the same as those of the first embodiment.

Effects similar to those of the assay device 1 according to the aforementioned first embodiment are obtained by the assay device 10 according to the second embodiment as well. Also, according to the assay device 10 of the second embodiment, it is possible to perform an assay on a plurality of liquids at the same time in a parallel manner.

### Third Embodiment

In the first embodiment and the second embodiment described above, the upper flow passage forming member 11, the lower flow passage forming member 12, the lower case 17, and the like are constituted by three-dimensional molded articles of a synthetic resin, and further, the separating flow passage 32 is provided with the narrowed width portion 321 with a narrowed flow passage width. In a third embodiment, an assay device is produced using a stacked structure in which each member with a flat plate shape is stacked, and a simple configuration in which no narrowed width portion is provided in a separating flow passage is employed. Hereinafter, differences from the first embodiment described above will be mainly described.

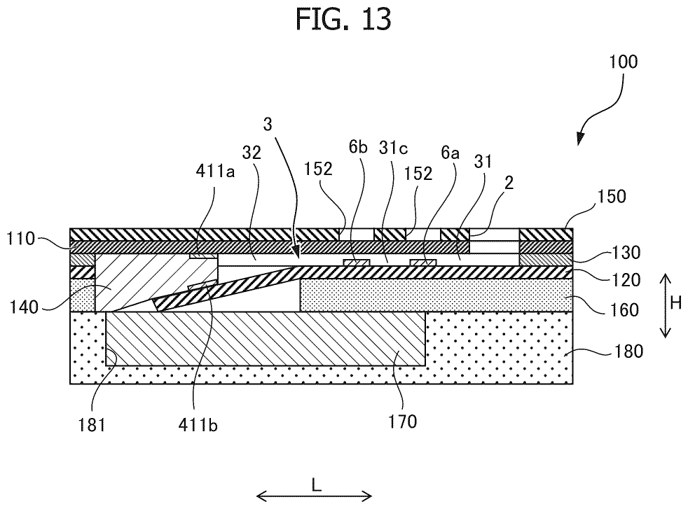

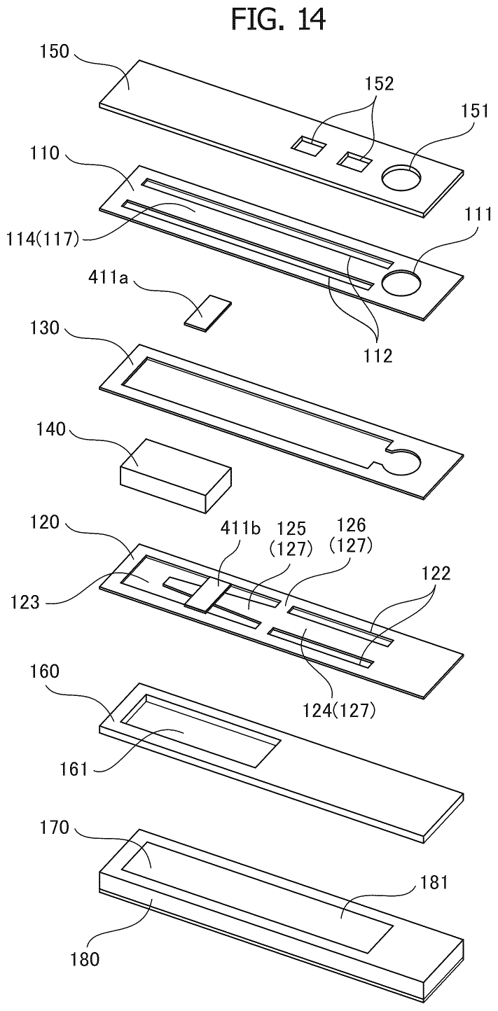

FIG. 13 illustrates a schematic sectional view of an assay device 100 according to the third embodiment, and FIG. 14 illustrates an exploded perspective view of the assay device 100. The assay device 100 mainly includes an upper cover 150, an upper flow passage forming member 110, an intermediate member 130, a first liquid absorbing material 140, a lower flow passage forming member 120, a housing member 160, a second liquid absorbing material 170, and a lower case 180.

The upper flow passage forming member 110 and the lower flow passage forming member 120 are formed of a transparent synthetic resin to have flexibility as in the first embodiment described above. In the present embodiment, the inner flow passage 3 is formed by the upper flow passage forming member 110, the lower flow passage forming member 120, and the intermediate member 130 that functions as a spacer between the upper flow passage forming member 110 and the lower flow passage forming member 120 being stacked as in the first embodiment described above.

The liquid injected from inlet 2 disposed on one side (the right side in FIG. 13) of the assay device 100 in a longitudinal direction L flows through the inner flow passage 3, and the liquid that has passed through the inner flow passage 3 is absorbed by the first liquid absorbing material 140 disposed on the other side (the left side in FIG. 13) in longitudinal direction L. The first liquid absorbing material 140 is formed into a block shape from a flexible porous material or the like that can absorb the liquid. The barrier forming members 411a and 411b that function as a flow passage surface changing portion that provides a change in the surface of the separating flow passage 32 with which the liquid comes into contact are mounted on the first liquid absorbing material 140 to promote separation of the liquid on one side of the first liquid absorbing material 140, that is, on the upstream side as in the first embodiment.

The upper flow passage forming member 110 is formed as a flat plate-shaped member with a rectangular outer shape in a top view. In the upper flow passage forming member 110, a first circular hole 111 with a circular shape in a top view and a pair of first slit holes 112 and 112 with rectangular shapes in a top view are formed. The first circular hole 111 and the pair of first slit holes 112 and 112 penetrate through the upper flow passage forming member 110 in height direction H. In the upper flow passage forming member 110, an upper wall portion 117 constituting an upper wall of the inner flow passage 3 is formed by a first inter-slit part 114 sandwiched between the pair of first slit holes 112 and 112.

The lower flow passage forming member 120 is formed as a flat plate-shaped member with an outer shape that is substantially the same as the outer shape of the upper flow passage forming member 110. In the lower flow passage forming member 120, a pair of second slit holes 122 and 122 with rectangular shapes in a top view and a U-shaped hole 123 with substantially U shape facing sideways in a top view are formed. The pair of second slit holes 122 and 122 and the U-shaped hole 123 penetrate through the lower flow passage forming member 120 in height direction H.

The pair of second slit holes 122 and 122 and a pair of straight parts of the U-shaped hole 123 are formed to correspond to the pair of first slit holes 112 and 112 in the upper flow passage forming member 110. In other words, the pair of second slit holes 122 and 122 and the pair of straight parts of the U-shaped hole 123 are formed to be located below the pair of first slit holes 112 and 112 in the upper flow passage forming member 110 when the upper flow passage forming member 110, the intermediate member 130, and the lower flow passage forming member 120 are stacked.

A second inter-slit part 124 sandwiched by the pair of second slit holes 122 and 122, an inner part 125 inside the U-shaped hole 123, and a second connecting part 126 that establishes connection between the second inter-slit part 124 and the inner part 125 form a lower wall portion 127 that constitutes a lower wall of the inner flow passage 3. Also, the second inter-slit part 124 and the second connecting part 126 constitute a lower wall of the microflow passage 31, and the inner part 125 constitutes a lower wall of the separating flow passage 32.

The upper cover 150 is formed into a flat plate shape from a synthetic resin, for example. The upper cover 150 has an outer shape that is substantially the same as the outer shape of the upper flow passage forming member 110 and is attached to the upper surface of the upper flow passage forming member 110 using a double-sided adhesive sheet or the like, which is not illustrated. A second circular hole 151 with a circular shape in a top view and observation windows 152 and 152 with rectangular shapes in a top view are formed in the upper cover 150. The second circular hole 151 and the observation windows 152 and 152 penetrate through the upper cover 150 in height direction H.

In the present embodiment, the first circular hole 111 in the upper flow passage forming member 110 and the second circular hole 151 in the upper cover 150 form the inlet 2. Also, the observation windows 152 and 152 are disposed above the first assay reagent 6a and the second assay reagent 6b in the assay region 31c of the microflow passage 31.

The housing member 160 is configured with a molded article of a synthetic resin, for example. The housing member 160 has an outer shape that is substantially the same as the outer shape of the lower flow passage forming member 120 and is attached to the lower surface of the lower flow passage forming member 120 using a double-sided adhesive sheet or the like, which is not illustrated. An opening 161 with a rectangular shape in a top view is formed in the housing member 160. The opening 161 penetrates through the housing member 160 in height direction H.

The lower case 180 is configured with a molded article of a synthetic resin, for example. The lower case 180 has an outer shape that is substantially the same as the outer shape of the housing member 160, and is attached to a lower surface of the housing 160 using a double-sided adhesive sheet or the like, which is not illustrated. The lower case 180 includes an accommodating portion 181 with an upper surface opening to accommodate the second liquid absorbing material 170. The second liquid absorbing material 170 is formed into a block shape that is larger than the first liquid absorbing material 140 and is disposed inside the accommodating portion 181 of the lower case 180.

The barrier forming members 411a and 411b may be formed by disposing double-sided adhesive sheets on the upper surface and the lower surface of a sheet material, respectively, as in the first embodiment described above. The barrier forming members 411a and 411b are attached to the upper surface and the lower surface of the first liquid absorbing material 140 via the double-sided adhesive sheets, respectively. More specifically, the barrier forming member 411a is disposed on the upper surface of the end portion of the first liquid absorbing material 140 on one side, that is, the upstream side, while the barrier forming member 411b is disposed on the lower surface of the end portion of the first liquid absorbing material 140 on the one side, that is, the upstream side. However, the barrier forming members 411a and 411b are not limited thereto, and a configuration in which the barrier forming members 411a and 411b are mounted on at least one of the upper surface and the lower surface of the first liquid absorbing material 140 may also be employed.

The assay device 100 illustrated in FIG. 13 is obtained by each member (component) illustrated in FIG. 14 being assembled. The obtained assay device 100 includes the inner flow passage 3 that includes the inlet 2, into which the liquid is injected, in an upper surface and allows the liquid injected from the inlet 2 to flow therethrough, and the first liquid absorbing material 140 that absorbs the liquid that has passed through the inner flow passage 3 as described above. The inner flow passage 3 includes the microflow passage 31 that communicates with the inlet 2, and the separating flow passage 32 that is provided between the microflow passage 31 and the first liquid absorbing material 140 and separates the liquid inside the inner flow passage 3 when injection of the liquid is stopped.

The inner part 125 of the lower flow passage forming member 120 is bent and deformed downward by abutting the first liquid absorbing material 140 in the block shape and by being pressurized by first liquid absorbing material 140 that is disposed on a downstream end side of the U-shaped hole 123 of the lower flow passage forming member 120 when the upper flow passage forming member 110, the lower flow passage forming member 120, and the intermediate member 130 are stacked and integrated. Therefore, the separating flow passage 32, that extends from the microflow passage 31 toward the first liquid absorbing material 140 and is inclined downward such that a lower wall is further lowered as it approaches the first liquid absorbing material 140, is formed by the upper flow passage forming member 110, the lower flow passage forming member 120, and the intermediate member 130 being stacked and integrated.

Once the liquid is injected from the inlet 2, a force of trying to stay inside the microflow passage 31 due to an interfacial tension and a capillary force of the first liquid absorbing material 140 act on the liquid inside the inner flow passage 3, and a state in which the liquid is pulled between the microflow passage 31 and the first liquid absorbing material 140 is achieved, as in the first embodiment described above. At this time, the liquid pulled from the upstream side and the downstream side is in a state in which the liquid is likely to be divided on the upstream side and the downstream side due to the presence of the barrier forming members 411a and 411b.

Thereafter, once the injection of the liquid is stopped, the liquid inside the inner flow passage 3 is divided by the separating flow passage 32, a part thereof is absorbed by the first liquid absorbing material 140, and the rest is left inside the microflow passage 31. In other words, the liquid inside the inner flow passage 3 is separated into a part that is left inside the microflow passage 31 and a part that is absorbed by the first liquid absorbing material 140.

It is possible to achieve effects and advantages that are similar to those of the first embodiment described above by mounting the barrier forming members 411a and 411b on the separating flow passage 32 in the third embodiment described above as well. In addition, the inner flow passage 3 can be a tapered flow passage or a straight flow passage as a whole by forming the separating flow passage 32 as a straight structure that does not include the narrowed width portion 321. Note that a plurality of inlets 2 and a plurality of inner flow passages 3 may be provided in the assay device 100 according to the third embodiment as well as in the second embodiment described above.

### Fourth Embodiment

The present invention can also be applied to an assay device configured to be able to use a minute amount of liquid and conduct an assay based on the electrochemical method. In a fourth embodiment, a flow passage surface changing portion that provides a change in a surface of a separating flow passage 32 is provided in the assay device that performs an assay based on the electrochemical method to promote separation of a liquid as in the embodiments described above.

The assay device according to the fourth embodiment is configured using a stacked structure in which each member with a flat plate shape is stacked as in the third embodiment described above. Hereinafter, differences from the third embodiment will be mainly described.

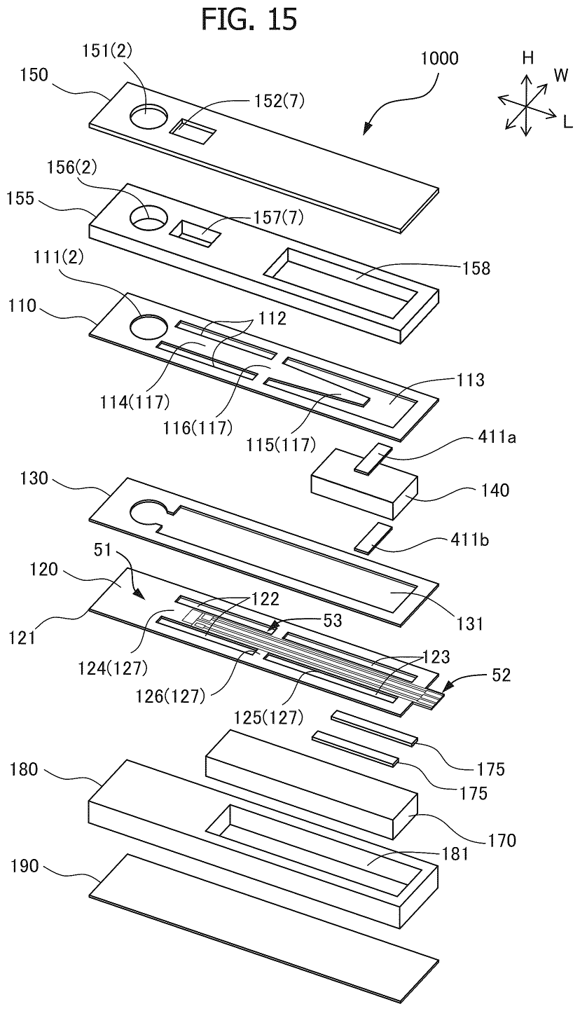

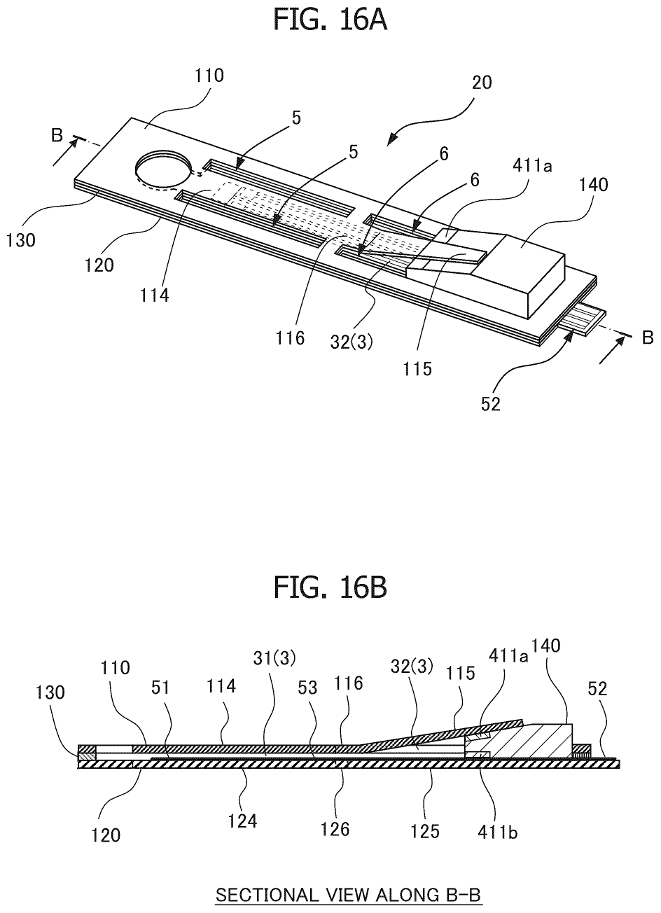

FIG. 15 is an exploded perspective view of an assay device 1000 according to the fourth embodiment. FIGS. 16A and 16B are diagrams illustrating a structure 20 (including first liquid absorbing material 140) in which an upper flow passage forming member 110, a lower flow passage forming member 120, and an intermediate member 130 are stacked and integrated, where FIG. 16A is a perspective view of the structure 20, and FIG. 16B is a sectional view along B-B in FIG. 16A.

The assay device 1000 mainly includes an upper cover 150, an upper housing 155, an upper flow passage forming member 110, an intermediate member 130, a first liquid absorbing material 140, a lower flow passage forming member 120, a second liquid absorbing material 170, a lower housing 180, and a lower cover 190. The inner flow passage 3 is formed by the upper flow passage forming member 110, the lower flow passage forming member 120, and the intermediate member 130 that functions as a spacer between the upper flow passage forming member 110 and the lower flow passage forming member 120 being stacked as in the third embodiment described above.

A liquid injected from the inlet 2 disposed on one side (the left side in FIG. 16B) of the assay device 100 in a longitudinal direction L flows through the inner flow passage 3, and the liquid that has passed through the inner flow passage 3 is absorbed by the first liquid absorbing material 140 disposed on the other side (the right side in FIG. 16B) in longitudinal direction L. The first liquid absorbing material 140 is formed into a block shape from a flexible porous material or the like that can absorb the liquid. The barrier forming members 411a and 411b that function as a flow passage surface changing portion that provides changes in the surface of the separating flow passage 32 with which the liquid comes into contact are mounted on the first liquid absorbing material 140 to promote separation of the liquid on one side of the first liquid absorbing material 140, that is, the upstream side as in the third embodiment.

The upper flow passage forming member 110 is formed as a flat plate-shaped member with a rectangular outer shape in a top view. A first circular hole 111 with a circular shape in a top view, a pair of first slit holes 112 and 112 with rectangular shapes in a top view, and a U-shaped hole 113 with a substantially U shape facing sideways in a top view are formed in the upper flow passage forming member 110. The first circular hole 111, the pair of first slit holes 112 and 112, and the U-shaped hole 113 penetrate through the upper flow passage forming member 110 in a height direction H. A first inter-slit part 114 sandwiched between the pair of first slit holes 112 and 112, an inner part 115 inside the U-shaped hole 113, and a first connecting part 116 that establishes connection between the first inter-slit part 114 and the inner part 115 form the upper wall portion 117 constituting an upper wall of the inner flow passage 3. In addition, the first inter-slit part 114 and the first connecting part 116 constitute an upper wall of the microflow passage 31, and the inner part 115 constitutes an upper wall of the separating flow passage 32.

The lower flow passage forming member 120 is formed as a flat plate-shaped member with an outer shape that is substantially the same as the outer shape of the upper flow passage forming member 110. A pair of the second slit holes 122 and 122 with rectangular shapes in a top view and a pair of third slit holes 123 and 123 with rectangular shapes in a top view are formed in the lower flow passage forming member 120. The pair of second slit holes 122 and 122 and the pair of third slit holes 123 and 123 penetrate through the lower flow passage forming member 12 in height direction H.

The pair of second slit holes 122 and 122 are formed to correspond to the pair of first slit holes 112 and 112 in the upper flow passage forming member 11. The pair of third slit holes 123 and 123 are formed to correspond to a pair of straight parts of the U-shaped hole 113 of the upper flow passage forming member 11.

The second inter-slit part 124 sandwiched between the pair of second slit holes 122 and 122, the third inter-slit part 125 sandwiched between the pair of third slit holes 123 and 123, and the second connecting part 126 that establishes connection between the second inter-slit part 124 and the third inter-slit part 125 form lower wall portion 127 constituting a lower wall of the inner flow passage 3. Also, the second inter-slit part 124 and the second connecting part 126 constitute a lower wall of the microflow passage 31, and the third inter-slit part 125 constitutes a lower wall of the separating flow passage 32.

Furthermore, an electrode portion 51, a connecting portion 52, and a conductor wire portion 53 for an assay based on the electrochemical method are formed in the lower flow passage forming member 12. Specifically, the electrode portion 51, the connecting portion 52, and the conductor wire portion 53 are formed integrally with the lower flow passage forming member 12 by a conductive material being printed on the upper surface of the lower flow passage forming member 12 in the present embodiment. Although examples of the conductive material include conductive carbon, gold, silver, silver chloride, platinum, nickel, graphite, palladium, iron, copper, zinc, a carbon paste, a mesh electrode, diamond, an indium-tin oxide (ITO) electrode, and the like, the conductive material is not limited thereto. In addition, although the electrode portion, the connecting portion, and the conductor wire portion are preferably printed using the same material, the electrode portion, the connecting portion, and the conductor wire portion may be printed using mutually different materials. Note that since the assay based on the electrochemical method does not have a direct relationship with the separation of the liquid achieved by separating flow passage 32, details thereof will be omitted.

The upper housing 155 is configured with a molded article of a synthetic resin, for example. The upper housing 155 has an outer shape that is substantially the same as the outer shape of upper flow passage forming member 110 and is attached to the upper surface of the upper flow passage forming member 110 using a double-sided adhesive sheet or the like, which is not illustrated. A second circular hole 156 with a circular shape in a top view, a first window hole 157 with a rectangular shape in a top view, and an opening 158 with a rectangular shape in a top view are formed in the upper housing 155. The second circular hole 156, the first window hole 157, and the opening 158 penetrate through the upper housing 14 in height direction H.

The second circular hole 156 is formed at a position corresponding to the first circular hole 111 in the upper flow passage forming member 110 and constitutes a part of the inlet 2. The first window hole 157 is formed to be located above the electrode portion 51 of the lower flow passage forming member 120 and constitutes a part of the observation window 7. The opening 158 is formed at a position corresponding to the U-shaped hole 113 in the upper flow passage forming member 110 and has a size with which the opening 158 can include the U-shaped hole 113 therein.

The upper cover 150 is configured with a molded article of a synthetic resin, for example. The upper cover 150 is formed into a flat plate shape, has an outer shape that is substantially the same as the outer shape of the upper housing 155, and is attached to the upper surface of the upper housing 155 using a double-sided adhesive sheet or the like, which is not illustrated. The third circular hole 151 with the circular shape and the second window hole 152 with the rectangular shape formed in the upper cover 150 penetrate through the upper cover 150 in height direction H.

In the present embodiment, the first circular hole 111 in the upper flow passage forming member 110, the second circular hole 156 in the upper housing 155, and the third circular hole 151 in the upper cover 150 form the inlet 2. Moreover, the first window hole 157 in the upper housing 155 and the second window hole 152 in the upper cover 150 form the observation window 7.

A pair of third liquid absorbing materials 175 and 175 are formed of a porous material or the like that can absorb the liquid similarly to the first liquid absorbing material 140. Each of the pair of third liquid absorbing materials 175 and 175 are formed into a thin and long block shape and is disposed on the other side in longitudinal direction L inside the pair of third slit holes 123 and 123 in the lower flow passage forming member 120.

The second liquid absorbing material 170 is formed of a block-shaped porous material or the like that can absorb the liquid similarly to the first liquid absorbing material 140 and the pair of third liquid absorbing materials 175 and 175.

The lower housing 180 is configured with a molded article of a synthetic resin, for example. The lower housing 180 has an outer shape that is substantially the same as the outer shapes of the upper flow passage forming member 110 and the upper housing 155 and is attached to the lower surface of the lower flow passage forming member 120 using a double-sided adhesive sheet or the like, which is not illustrated. The lower housing 180 includes the accommodating portion 181 with an upper surface opening to accommodate the second liquid absorbing material 170.

The lower cover 190 is configured with a molded article of a synthetic resin, for example. The lower cover 190 is formed into a flat plate shape, has an outer shape that is substantially the same as the outer shape of the lower housing 180, and is attached to the lower surface of the lower housing 180 using a double-sided adhesive sheet or the like, which is not illustrated.

The barrier forming members 411a and 411b may be formed by disposing double-sided adhesive sheets on an upper surface and a lower surface of a sheet material, respectively, as in the third embodiment described above, for example. The barrier forming members 411a and 411b are attached to the upper surface and the lower surface of the first liquid absorbing material 140 via the double-sided adhesive sheets, respectively. More specifically, the barrier forming member 411a is disposed on the upper surface of the end portion on one side of the first liquid absorbing material 140, that is, the upstream side, while the barrier forming member 411b is disposed on the lower surface of the end portion on the one side of the first liquid absorbing material 140, that is, the upstream side. However, the barrier forming members 411a and 411b are not limited thereto, and a configuration in which the barrier forming members 411a and 411b are mounted only on any one of the upper surface and the lower surface of the first liquid absorbing material 140 may also be employed.

The assay device 1000 is obtained by each member (component) illustrated in FIG. 15 being assembled. The obtained assay device 1000 includes the inner flow passage 3 that has the inlet 2, into which the liquid is injected, in the upper surface and allows the liquid injected from the inlet 2 to flow therethrough, and the first liquid absorbing material 140 that absorbs the liquid that has passed through the inner flow passage 3 as described above. The inner flow passage 3 includes the microflow passage 31 that communicates with the inlet 2 and the separating flow passage 32 that is provided between the microflow passage 31 and the first liquid absorbing material 140 for separating the liquid inside the inner flow passage 3 when the injection of the liquid is stopped.

As illustrated in FIGS. 16A and 16B, the inner part 115 of the upper flow passage forming member 110 is bent and is deformed upward by abutting the first liquid absorbing material 4 and by being pressurized by the first liquid absorbing material 140 that is disposed on the other side in longitudinal direction L inside the opening portion 131 of the intermediate member 130 when the upper flow passage forming member 110, the lower flow passage forming member 120, and the intermediate member 130 are stacked and integrated. Therefore, the separating flow passage 32, that extends from the microflow passage 31 toward the first liquid absorbing material 140 and is inclined upward such that the upper wall is higher as it approaches the first liquid absorbing material 140, is formed by the upper flow passage forming member 110, the lower flow passage forming member 120, and the intermediate member 130 being stacked and integrated.

Once the liquid is injected from the inlet 2, a force of trying to stay inside the microflow passage 31 due to an interfacial tension and a capillary force of the first liquid absorbing material 140 act on the liquid inside the inner flow passage 3, and a state in which the liquid is pulled between the microflow passage 31 and the first liquid absorbing material 140 is achieved, as in the first embodiment described above. At this time, the liquid pulled from the upstream side and the downstream side is in a state in which the liquid is likely to be divided on the upstream side and the downstream side due to the presence of the barrier forming members 411a and 411b.

Thereafter, once the injection of the liquid is stopped, the liquid inside the inner flow passage 3 is divided by the separating flow passage 32, a part thereof is absorbed by the first liquid absorbing material 140, and the rest is left inside the microflow passage 31. In other words, the liquid inside the inner flow passage 3 is separated into a part that is left inside the microflow passage 31 and a part that is absorbed by the first liquid absorbing material 140.

In the fourth embodiment described above, effects and advantages similar to those of the first embodiment described above can be exhibited by mounting the barrier forming members 411a and 411b while the separating flow passage 32 is shaped such that an upper wall thereof is located higher as it approaches the first liquid absorbing material 140. Also, a configuration in which a plurality of inlets 2 and a plurality of inner flow passages 3 are provided as in the second embodiment described above may be employed in the assay device 1000 according to the fourth embodiment as well.

### First Modification

In the first to fourth embodiments described above, the barrier forming members 410a, 410b, 411a, and 411b are mounted on the first liquid absorbing materials 4 and 140 to provide a step to the separating flow passage 32 as the flow passage surface changing portion that provides changes in the surface of the separating flow passage 32 with which the liquid comes into contact. However, the configuration of the flow passage changing portion is not limited thereto as long as it is possible to provide a change in the surface of the separating flow passage 32 with which the liquid comes into contact and to promote division of the liquid.

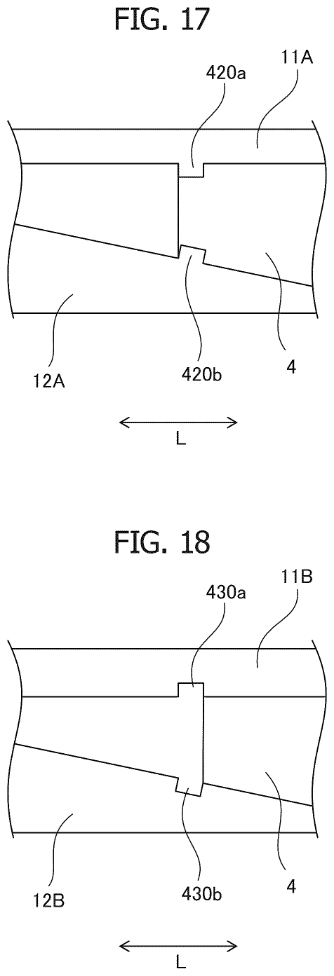

For example, it is also possible to provide a projecting portion that projects to the inside of the separating flow passage 32 on at least one of the upper wall portion and the lower wall portion of the inner flow passage 3 as the stepped structure of the flow passage surface changing portion. Specifically, it is possible to form projecting portions 420a and 420b as a step projecting from an upper flow passage forming member 11A and a lower flow passage forming member 12A constituting the upper wall and the lower wall of the inner flow passage 3 as illustrated in FIG. 17. The projecting portions 420a and 420b are disposed at positions corresponding to the end portion of the first liquid absorbing material 4 on the upstream side in the flowing direction of the liquid and extend in width direction W of the first liquid absorbing material 4. The dimension of the projecting portions 420a and 420b in height direction H is set in accordance with the height of the separating flow passage 32, the composition of the liquid that is injected into the assay device 1, and the like to promote division of the liquid.

Note that the projecting portions 420a and 420b may be formed only on any one of the upper flow passage forming member 11A and the lower flow passage forming member 12A. Also, the projecting portions 420a and 420b may be disposed on the side further upstream than the end portion of the first liquid absorbing material 4 on the upstream side, that is, at the other end portion (downstream end) of the separating flow passage 32. In other words, the projecting portions 420a and 420b can be disposed near a boundary between the other end portion of the separating flow passage 32 and the first liquid absorbing material 4.

The projecting portions 420a and 420b may be formed integrally with the upper flow passage forming member 11A and the lower flow passage forming member 12A as three-dimensional molded articles, for example, or may be formed as members separated from the upper flow passage forming member 11A and the lower flow passage forming member 12A so as to be joined thereto.

### Second Modification

It is also possible to provide a groove portion in at least one of the upper wall portion and the lower wall portion of the inner flow passage 3 as a stepped structure of the flow passage surface changing portion. Specifically, it is possible to form groove portions 430a and 430b as recessed portions formed in an upper flow passage forming member 11B and a lower flow passage forming member 12B constituting the upper wall and the lower wall of the inner flow passage 3 as illustrated in FIG. 18. The groove portions 430a and 430b are disposed at the positions corresponding to the end portion of the first liquid absorbing material 4 on the upstream side in the flowing direction of the liquid and extend in width direction W of the first liquid absorbing material 4. The dimension of the groove portions 430a and 430b in height direction H is set in accordance with the height of the separating flow passage 32, the composition of the liquid injected into the assay device 1, and the like to promote division of the liquid.

Note that the groove portions 430a and 430b may be formed only in any one of the upper flow passage forming member 11B and the lower flow passage forming member 12B. In addition, the groove portions 430a and 430b may be disposed on the side further upstream than the end portion of the first liquid absorbing material 4 on the upstream side, that is, at the other end portion (downstream end) of the separating flow passage 32. In other words, the groove portions 430a and 430b may be disposed near the boundary between the other end portion of the separating flow passage 32 and the first liquid absorbing material 4.

### Third Modification

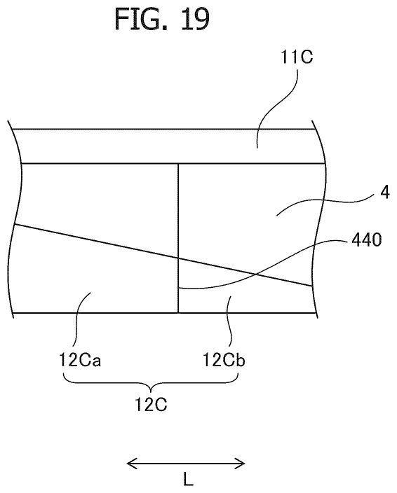

The flow passage surface changing portion is not limited to the stepped structure as long as it is possible to provide a change in the surface of the separating flow passage 32 with which the liquid comes into contact. For example, as illustrated in FIG. 19, it is possible to form a lower flow passage forming member 12C constituting the lower wall portion of the inner flow passage 3 as a member that is formed by joining a first member 12Ca, that is disposed on the side further upstream than the end portion of the first liquid absorbing material 4 on the upstream side in the flowing direction of the liquid, and a second member 12Cb, that is disposed on the side further downstream than the end portion of the first liquid absorbing material 4 on the upstream side such that a joined portion 440 between the first member 12Ca and the second member 12Cb serves as a flow passage surface changing portion. The liquid pulled from the upstream side and the downstream side inside the separating flow passage 32 is likely to be divided on the upstream side and the downstream side due to the presence of the joined portion (seam) 440, and separation of the liquid on the upstream side of the first liquid absorbing material 4 is thereby promoted. Note that an upper flow passage forming member 11C constituting the upper wall portion of the inner flow passage 3 may be provided with a joined portion (seam) instead of, or in addition to, the joined portion 440 of the lower flow passage forming member 12C.

### Fourth Modification

The flow passage surface changing portion is not limited to a change in shape of the surface of the separating flow passage 32 as described above as long as it is possible to provide a change in the surface of the separating flow passage 32 with which the liquid comes into contact. For example, it is possible to perform a surface treatment to promote separation of the liquid on the surface of the separating flow passage 32 with which the liquid comes into contact. The surface treatment includes a treatment of changing the polarity of the surface of the separating flow passage 32 to be partially hydrophobic. In an example, a hydrophobization surface treatment is performed on a surface region near the boundary between the other end of the separating flow passage 32 and the first liquid absorbing material 4 on at least any one of the upper flow passage forming member 11 and the lower flow passage forming member 12 constituting the upper wall and the lower wall of the inner flow passage 3. The range (area) in which the surface treatment is performed is set in accordance with the height of the separating flow passage 32, the composition of the liquid injected into the assay device 1, and the like to promote division of the liquid. In this manner, separation of the liquid on the upstream side of the first liquid absorbing material 4 is promoted.

Although the embodiments and modifications of the present invention have been described hitherto, it is a matter of course that the present invention is not limited to the aforementioned embodiments and modifications and changes can be made based on the technical concept of the present invention. Moreover, it is also possible to freely combine the aforementioned embodiments and modifications thereof.

### REFERENCE SIGNS LIST

1, 10, 100, 1000 Assay device
2 Inlet
3 Inner flow passage
4 First liquid absorbing material
4a Upper absorbing material
4b Lower absorbing material
11, 11A, 11B, 11C, 110 Upper flow passage forming member
12, 12A, 12B, 12C, 120 Lower flow passage forming member
12Ca First member
12Cb Second member
13, 130 Intermediate member
31 Microflow passage
32 Separating flow passage
111, 117 Upper wall portion
121, 127 Lower wall portion
410a, 410b, 411a, 411b Barrier forming member
420a, 420b Projecting portion
430a, 430b Groove portion
440 Joined portion
LQ1 First liquid
LQ2 Second liquid

1. An assay device comprising:
an inlet;
an inner flow passage through which a liquid injected from the inlet flows; and
a liquid absorbing material that absorbs the liquid that has passed through the inner flow passage, wherein:
the inner flow passage includes
a microflow passage that includes an assay region, and
a separating flow passage that is provided between the microflow passage and the liquid absorbing material for separating the liquid inside the inner flow passage into a part that is left in the microflow passage and a part that is absorbed by the liquid absorbing material when injection of the liquid is stopped; and
the separating flow passage includes a flow passage surface changing portion that provides a change in a surface of the separating flow passage with which the liquid comes into contact.

2. The assay device according to claim 1, wherein the flow passage surface changing portion includes a stepped structure that provides a step to the separating flow passage.

3. The assay device according to claim 2, wherein the stepped structure of the flow passage surface changing portion is formed of a material that does not allow the liquid to penetrate through the material, and includes a barrier forming member that is mounted on an end portion of the liquid absorbing material on an upstream side in a flowing direction of the liquid.

4. The assay device according to claim 3, wherein the barrier forming member is mounted on at least one of an upper surface and a lower surface of the liquid absorbing material.

5. The assay device according to claim 2, comprising:
a lower flow passage forming member that includes a lower wall portion formed to constitute a lower wall of the inner flow passage;
an intermediate member that is joined to an upper surface of the lower flow passage forming member; and
an upper flow passage forming member that is joined to an upper surface of the intermediate member, and includes an upper wall portion formed to constitute an upper wall of the inner flow passage, wherein:
the inner flow passage is configured with the upper flow passage forming member, the lower flow passage forming member, and the intermediate member that functions as a spacer between the upper flow passage forming member and the lower flow passage forming member; and
the stepped structure of the flow passage surface changing portion is a projecting portion that is formed on at least one of the upper wall portion and the lower wall portion, and projects to inside of the separating flow passage at a position corresponding to an end portion of the liquid absorbing material on an upstream side in a flowing direction of the liquid.

6. The assay device according to claim 2, comprising:
a lower flow passage forming member that includes a lower wall portion formed to constitute a lower wall of the inner flow passage;
an intermediate member that is joined to an upper surface of the lower flow passage forming member; and
an upper flow passage forming member that is joined to an upper surface of the intermediate member, and includes an upper wall portion formed to constitute an upper wall of the inner flow passage, wherein:
the inner flow passage is configured with the upper flow passage forming member, the lower flow passage forming member, and the intermediate member that functions as a spacer between the upper flow passage forming member and the lower flow passage forming member; and
the stepped structure of the flow passage surface changing portion is a groove portion that is formed in at least one of the upper wall portion and the lower wall portion at a position corresponding to an end portion of the liquid absorbing material on an upstream side in a flowing direction of the liquid.

7. The assay device according to claim 1, comprising:
a lower flow passage forming member that includes a lower wall portion formed to constitute a lower wall of the inner flow passage;
an intermediate member that is joined to an upper surface of the lower flow passage forming member; and
an upper flow passage forming member that is joined to an upper surface of the intermediate member, and includes an upper wall portion formed to constitute an upper wall of the inner flow passage, wherein:
the inner flow passage is configured with the upper flow passage forming member, the lower flow passage forming member, and the intermediate member that functions as a spacer between the upper flow passage forming member and the lower flow passage forming member;
the lower flow passage forming member is a member formed by joining a first member that is disposed on a side further upstream than the end portion of the liquid absorbing material on the upstream side in a flowing direction of the liquid and a second member that is disposed on a side further downstream than the end portion of the liquid absorbing material on the upstream side; and
the flow passage surface changing portion is a joined portion of the first member and the second member.
